(19) United States
(12) Patent Application Publication
(10) Pub. No.: US 2026/0263929 A1
(43) Pub. Date: Sep. 10, 2026

(54) ONE OR MORE NON-TRANSITORY COMPUTER-READABLE STORAGE MEDIA, GAME APPARATUS, GAME SYSTEM, AND COMPUTER-IMPLEMENTED METHOD

(71) Applicant: Nintendo Co., Ltd., Kyoto (JP)

(72) Inventors: Naonori OHNISHI, Kyoto (JP); Kento MORITA, Kyoto (JP)

(21) Appl. No.: 19/536,850

(22) Filed: Feb. 11, 2026

(30) Foreign Application Priority Data
Mar. 5, 2025 (JP) 2025-034198

(51) Int. Cl. A63F 13/5258; A63F 13/213; A63F 13/525

(52) U.S. Cl. CPC A63F 13/5258; A63F 13/213; A63F 13/525

(57) ABSTRACT

In a first mode, a gazing point is set based on a reference point moved based on an operation input, and a first process is executed when a determination instruction is made when a first cursor overlaps a first‑type object. In a second mode, a virtual camera is placed at a position closer to a virtual plane than in the first mode, the reference point is moved based on an operation input, the gazing point is set such that a first area where the first‑type object is placed does not overlap a second cursor, and the first process is executed when the determination instruction is made when a second area not overlapping the first area and corresponding to the first‑type object overlaps the second cursor.

### CROSS REFERENCE TO RELATED APPLICATION

This application claims priority to Japanese Patent Application No. 2025-34198 filed on Mar. 5, 2025, the entire contents of which are incorporated herein by reference.

### FIELD

The present disclosure relates to game processing in which an image of a virtual space is captured by a virtual camera that can be operated by a user.

### BACKGROUND AND SUMMARY

Conventionally, a game, in which, based on an operation performed by a user, the position of a virtual camera within a virtual space can be moved closer to or away from a target of interest, has been known.

Regarding the game as described above, there is room for improvement in an operation method corresponding to the position of the virtual camera.

In view of the above, the following configuration examples are exemplified.

### Configuration Example 1

Configuration Example 1 is directed to one or more non-transitory computer-readable storage media having stored therein instructions that, when executed, cause one or more processors to perform operations including:

switching between a first mode and a second mode based on an operation input;

in the first mode,

moving a reference point based on an operation input,

setting a gazing point of a virtual camera within a virtual space including a virtual plane on which a first‑type object is placed, based on the reference point,

generating, based on the virtual camera, a first game image in which a first cursor is displayed at a predetermined position, and

executing a first process related to the first‑type object when the first cursor overlaps the first‑type object and a determination instruction is made based on an operation input; and

in the second mode,

placing the virtual camera at a position closer to the virtual plane than a position of the virtual camera in the first mode,

moving the reference point based on an operation input,

generating, based on the virtual camera, a second game image in which a second cursor is displayed at a position, on the virtual plane, determined based on the reference point,

hiding at least a part of the first‑type object when the first‑type object is positioned within a predetermined range from the virtual camera,

setting the gazing point such that a first area where the first‑type object is placed does not overlap the second cursor, in setting of the gazing point based on the reference point, and

executing the first process related to the first‑type object when the determination instruction is made based on an operation input when a second area that includes at least an area not overlapping the first area and corresponds to a position at which the first‑type object is placed overlaps the second cursor.

According to the above configuration example, an appropriate operation method corresponding to the position of the virtual camera can be provided.

### Configuration Example 2

In Configuration Example 2 based on Configuration Example 1 above, the operations may further include, based on an operation input, placing the first‑type object at a position, in the virtual space, based on the operation input.

### Configuration Example 3

In Configuration Example 3 based on Configuration Example 1 or 2 above, the operations may further include setting the gazing point based on the reference point such that the second cursor is displayed at a position overlapping the first area, when the first cursor overlaps the first‑type object and switching is made from the first mode to the second mode based on the operation input.

### Configuration Example 4

In Configuration Example 4 based on Configuration Example 1 or 2 above, the operations may further include restricting switching from the first mode to the second mode based on the operation input when the first cursor overlaps the first‑type object.

### Configuration Example 5

In Configuration Example 5 based on Configuration Example 1 or 2 above, the operations may further include setting the gazing point such that the second cursor is displayed at a position not overlapping the first area, when the first cursor overlaps the first‑type object and switching is made from the first mode to the second mode based on the operation input.

### Configuration Example 6

In Configuration Example 6 based on any one of Configuration Examples 1 to 5 above, a depression angle of the virtual camera in the first mode may be smaller than a depression angle of the virtual camera in the second mode.

### Configuration Example 7

In Configuration Example 7 based on any one of Configuration Examples 1 to 6 above, the operations may further include controlling a height of the virtual camera in the virtual space, based on a height of the reference point in the virtual space, in the second mode.

### Configuration Example 8

In Configuration Example 8 based on Configuration Example 7 above, the operations may further include: when the height of the reference point has changed from a first height to a second height, setting the height of the virtual camera from a height based on the first height to a height based on the second height; and when the height of the reference point has changed from the second height to the first height, setting the height of the virtual camera to the height based on the second height.

### Configuration Example 9

In Configuration Example 9 based on any one of Configuration Examples 1 to 8 above, the operations may further include: in the first mode, executing a second process related to a second-type object when the first cursor overlaps the second-type object and the determination instruction is made, and executing the first process related to the second-type object when the first cursor overlaps the second-type object and switching is made from the first mode to the second mode based on the operation input; and in the second mode, executing the first process related to the second-type object when the determination instruction is made when a third area corresponding to a position at which the second-type object is placed overlaps the second cursor.

### Configuration Example 10

In Configuration Example 10 based on any one of Configuration Examples 1 to 9 above, data regarding the first‑type object may be embedded in a pixel in a first range in the first game image, the first range including pixels at which the first‑type object is displayed, and the operations may further include executing the first process related to the first‑type object when the determination instruction is made when the first cursor overlaps the pixel in which the data regarding the first‑type object is embedded.

### Configuration Example 11

In Configuration Example 11 based on Configuration Example 10 above, the first range may be wider than a range where the first‑type object is displayed.

### Configuration Example 12

In Configuration Example 12 based on Configuration Example 11 above, the operations may further include displaying a first label indicating the first‑type object, at a pixel in a second range which is at least a part of the first range in the first game image.

### Configuration Example 13

In Configuration Example 13 based on Configuration Example 12 above, the operations may further include executing the first process related to another first‑type object when the determination instruction is made when a pixel which is included in the first area and at which the first‑type object is not displayed but the other first‑type object is displayed overlaps the first cursor.

### Configuration Example 14

In Configuration Example 14 based on Configuration Example 13 above, the operations may further include: when a pixel which is a pixel in the second range and at which the other first‑type object is displayed does not overlap the first cursor, displaying the first label and the other first‑type object at said pixel in an overlapping manner; and when a pixel which is a pixel in the second range and at which the other first‑type object is displayed overlaps the first cursor, hiding the first label and displaying the other first‑type object at said pixel.

### Configuration Example 15

In Configuration Example 15 based on any one of Configuration Examples 1 to 14 above, the operations may further include increasing a transparency of the first‑type object over time when the first‑type object is positioned within a first distance in a direction based on a direction of a line of sight of the virtual camera.

Each configuration example described above may be applied to a computer-implemented method, a game apparatus including one or more processors, and a game system including one or more processors.

### BRIEF DESCRIPTION OF THE DRAWINGS

FIG. 1 shows a non-limiting example of a state in which a left controller 3 and a right controller 4 are attached to a main body apparatus 2;

FIG. 2 shows a non-limiting example of a state in which the left controller 3 and the right controller 4 are detached from the main body apparatus 2;

FIG. 3 is six orthogonal views showing a non-limiting example of the main body apparatus 2;

FIG. 4 is six orthogonal views showing a non-limiting example of the left controller 3;

FIG. 5 is six orthogonal views showing a non-limiting example of the right controller 4;

FIG. 6 is a block diagram showing a non-limiting example of the internal configuration of the main body apparatus 2;

FIG. 7 is a block diagram showing a non-limiting example of the internal configurations of the main body apparatus 2, the left controller 3, and the right controller 4;

FIG. 8 shows a non-limiting example of a game screen according to an exemplary embodiment;

FIG. 9 shows a non-limiting example of the game screen according to the exemplary embodiment;

FIG. 10 illustrates a non-limiting example of a camera mode;

FIG. 11 shows a non-limiting example of the game screen according to the exemplary embodiment;

FIG. 12 shows a non-limiting example of a cursor collision area;

FIG. 13 shows a non-limiting example of an access area;

FIG. 14 illustrates a non-limiting example of building access in the case of a ground camera;

FIG. 15 illustrates a non-limiting example of the building access in the case of the ground camera;

FIG. 16 illustrates a non-limiting example of the building access in the case of the ground camera;

FIG. 17 illustrates types of buildings;

FIG. 18 illustrates a non-limiting example of a building access process;

FIG. 19 illustrates a non-limiting example of the building access process;

FIG. 20 illustrates a non-limiting example of building access to a C‑type building in the case of an overhead camera;

FIG. 21 illustrates a non-limiting example of building access to the C‑type building in the case of the overhead camera;

FIG. 22 illustrates a non-limiting example of the processing of a pick function;

FIG. 23 illustrates a non-limiting example of the processing of the pick function;

FIG. 24 illustrates a non-limiting example of the processing of the pick function;

FIG. 25 illustrates a non-limiting example of the processing of the pick function;

FIG. 26 illustrates a non-limiting example of the processing of the pick function;

FIG. 27 illustrates a non-limiting example of the processing of the pick function;

FIG. 28 is a memory map showing a non-limiting example of various data stored in a DRAM 85;

FIG. 29 shows a non-limiting example of the data structure of building data 303;

FIG. 30 shows a non-limiting example of the data structure of operation data 310;

FIG. 31 is a non-limiting example of a flowchart showing the details of game processing according to the exemplary embodiment;

FIG. 32 is a non-limiting example of a flowchart showing the details of a normal process;

FIG. 33 is a non-limiting example of a flowchart showing the details of a user operation process;

FIG. 34 is a non-limiting example of a flowchart showing the details of a camera operation process;

FIG. 35 is a non-limiting example of a flowchart showing the details of a popup label control process;

FIG. 36 is a non-limiting example of a flowchart showing the details of a building access determination process;

FIG. 37 is a non-limiting example of a flowchart showing the details of the building access determination process;

FIG. 38 is a non-limiting example of a flowchart showing the details of a virtual camera control process;

FIG. 39 is a non-limiting example of a flowchart showing the details of a game image generation process;

FIG. 40 is a non-limiting example of a flowchart showing the details of a building access process; and

FIG. 41 is a non-limiting example of a flowchart showing the details of the building access process.

### DETAILED DESCRIPTION OF NON-LIMITING EXAMPLE EMBODIMENTS

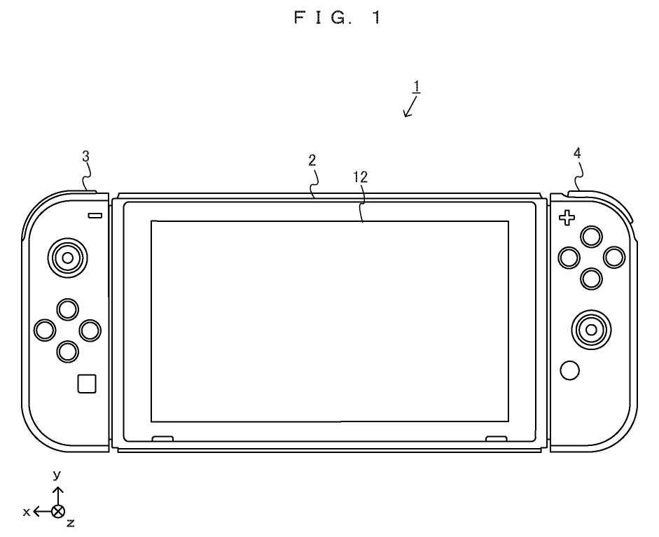

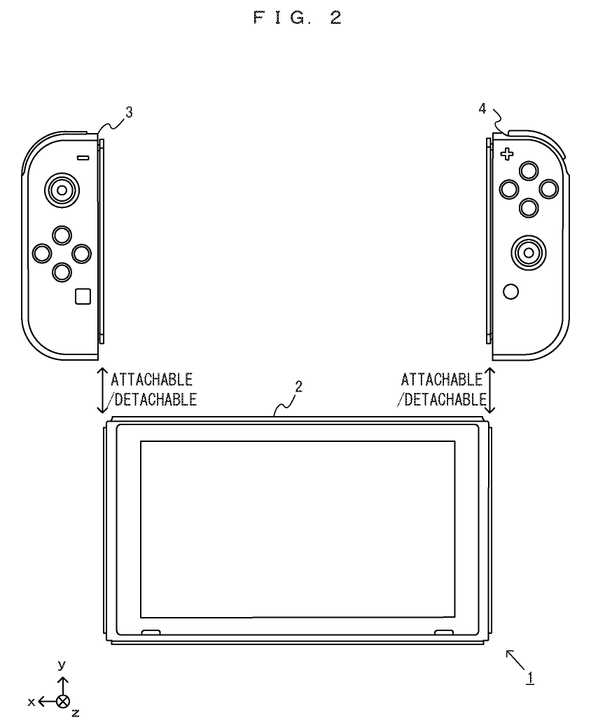

Hereinafter, an exemplary embodiment will be described. FIG. 1 shows an example of the appearance of a game system which is an example of an information processing system. An example of a game system 1 according to the exemplary embodiment includes a main body apparatus (an information processing apparatus, which functions as a game apparatus main body in the exemplary embodiment) 2 which is an example of a computer, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies (see FIG. 2). Hereinafter, first, the hardware configuration of the game system 1 according to the exemplary embodiment will be described, and then, the control of the game system 1 according to the exemplary embodiment will be described.

FIG. 1 shows an example of the state where the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a player provides inputs.

FIG. 2 shows an example of the state where each of the left controller 3 and the right controller 4 is detached from the main body apparatus 2. As shown in FIGS. 1 and 2, the left controller 3 and the right controller 4 are attachable to and detachable from the main body apparatus 2. Hereinafter, the left controller 3 and the right controller 4 may be collectively referred to as “controller”.

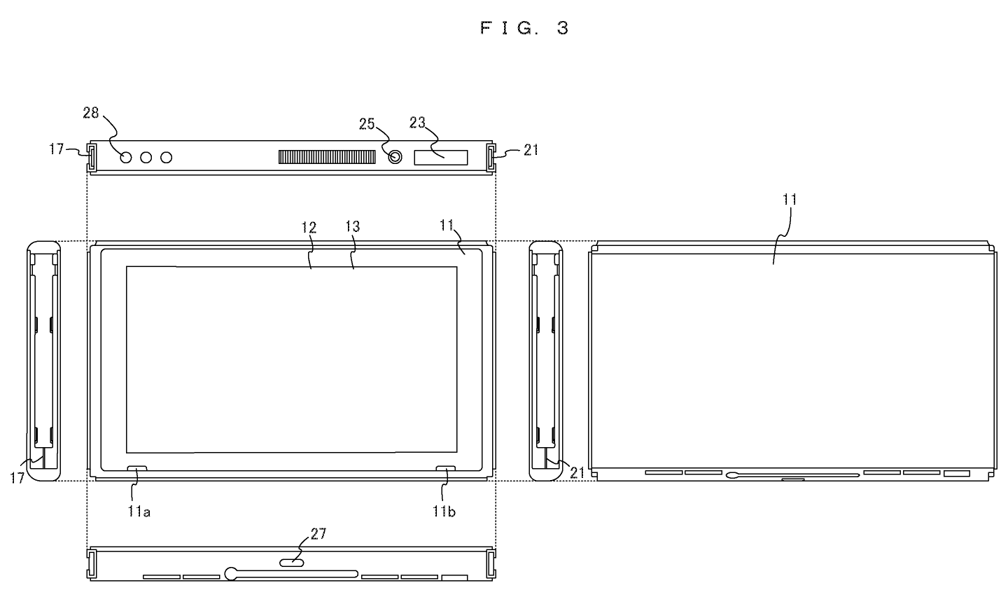

FIG. 3 is six orthogonal views showing an example of the main body apparatus 2. As shown in FIG. 3, the main body apparatus 2 includes an approximately plate-shaped housing 11. In the exemplary embodiment, a main surface (in other words, a surface on a front side, i.e., a surface on which the display 12 is provided) of the housing 11 has a substantially rectangular shape.

The shape and the size of the housing 11 are discretionary. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As shown in FIG. 3, the main body apparatus 2 includes the display 12, which is provided on the main surface of the housing 11. The display 12 displays an image generated by the main body apparatus 2. In the exemplary embodiment, the display 12 is a liquid crystal display device (LCD). The display 12, however, may be a display device of any type.

The main body apparatus 2 includes a touch panel 13 on the screen of the display 12. In the exemplary embodiment, the touch panel 13 is of a type capable of receiving a multi-touch input (e.g., electrical capacitance type). However, the touch panel 13 may be of any type, and may be, for example, of a type capable of receiving a single-touch input (e.g., resistive film type).

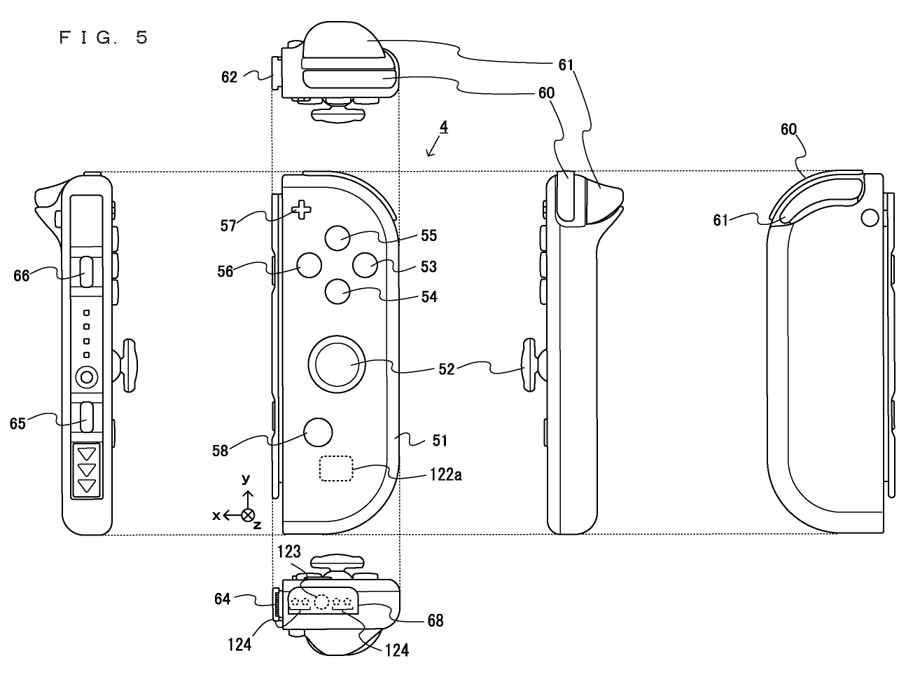

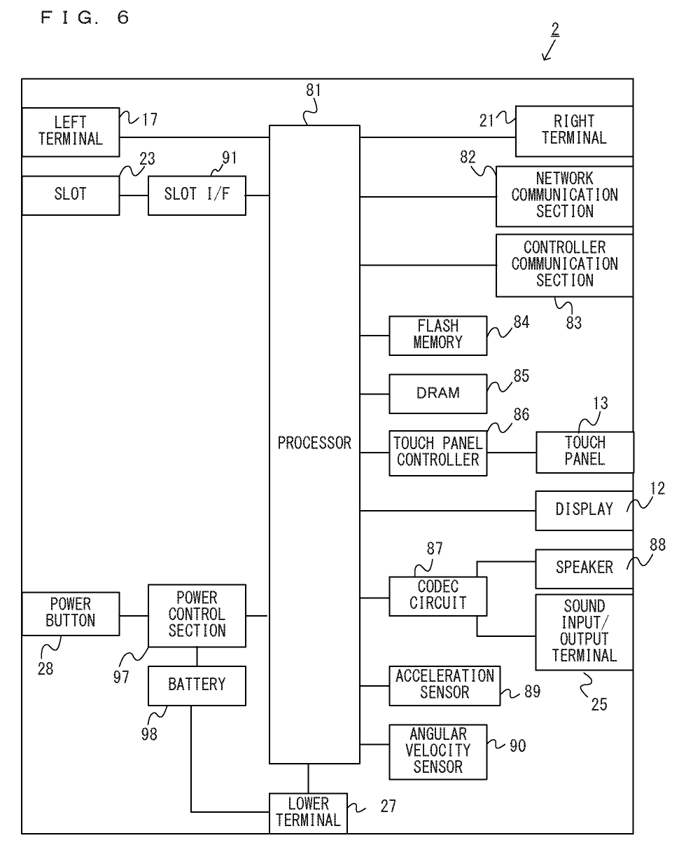

The main body apparatus 2 includes speakers (i.e., speakers 88 shown in FIG. 6) within the housing 11. As shown in FIG. 3, speaker holes 11a and 11b are formed in the main surface of the housing 11. Then, sounds outputted from the speakers 88 are outputted through the speaker holes 11a and 11b.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

As shown in FIG. 3, the main body apparatus 2 includes a slot 23. The slot 23 is provided at an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower terminal 27. The lower terminal 27 is a terminal for the main body apparatus 2 to communicate with a cradle. In the exemplary embodiment, the lower terminal 27 is a USB connector (more specifically, a female connector). Further, when the unified apparatus or the main body apparatus 2 alone is mounted on the cradle, the game system 1 can display on a stationary monitor an image generated by and outputted from the main body apparatus 2. Further, in the exemplary embodiment, the cradle has the function of charging the unified apparatus or the main body apparatus 2 alone mounted on the cradle. Further, the cradle has the function of a hub device (specifically, a USB hub).

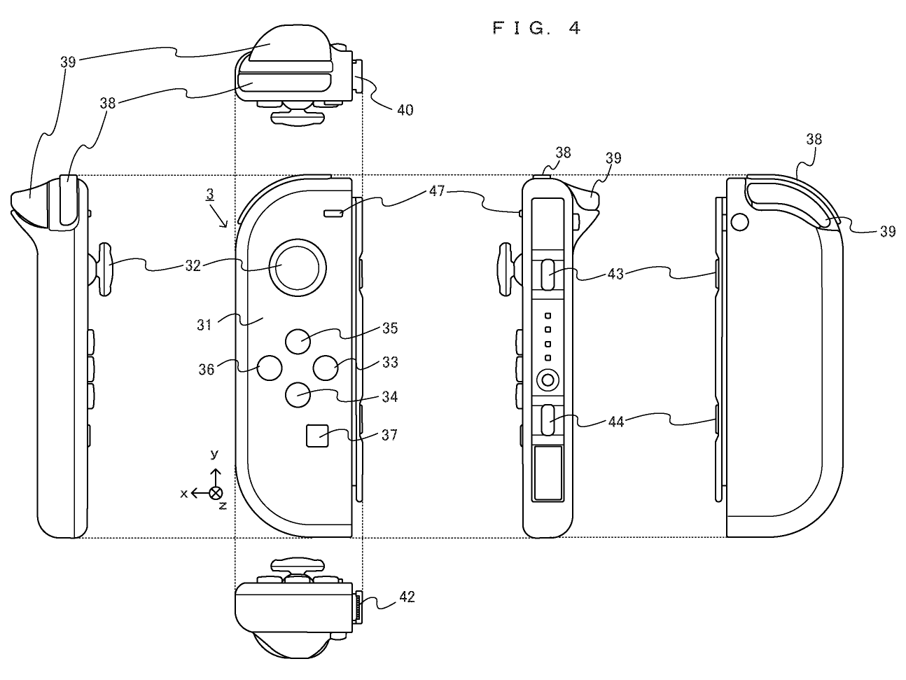

FIG. 4 is six orthogonal views showing an example of the left controller 3. As shown in FIG. 4, the left controller 3 includes a housing 31. In the exemplary embodiment, the housing 31 has a vertically long shape, i.e., is shaped to be long in an up-down direction shown in FIG. 4 (i.e., a y-axis direction shown in FIG. 4). In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly, the left hand. Further, the left controller 3 can also be held in the orientation in which the left controller 3 is horizontally long. When held in the orientation in which the left controller 3 is horizontally long, the left controller 3 may be held with both hands.

The left controller 3 includes a left analog stick (hereinafter, referred to as a “left stick”) 32 as an example of a direction input device. As shown in FIG. 4, the left stick 32 is provided on a main surface of the housing 31. The left stick 32 can be used as a direction input section with which a direction can be inputted. The player tilts the left stick 32 and thereby can input a direction corresponding to the direction of the tilt (and input a magnitude corresponding to the angle of the tilt). The left controller 3 may include a directional pad, a slide stick that allows a slide input, or the like as the direction input section, instead of the analog stick. Further, in the exemplary embodiment, it is possible to provide an input by pressing the left stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an OS program and an application program) executed by the main body apparatus 2.

Further, the left controller 3 includes a terminal 42 for the left controller 3 to perform wired communication with the main body apparatus 2.

FIG. 5 is six orthogonal views showing an example of the right controller 4. As shown in FIG. 5, the right controller 4 includes a housing 51. In the exemplary embodiment, the housing 51 has a vertically long shape, i.e., is shaped to be long in the up-down direction shown in FIG. 5 (i.e., the y-axis direction shown in FIG. 5). In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes a right analog stick (hereinafter, referred to as a “right stick”) 52 as a direction input section. In the exemplary embodiment, the right stick 52 has the same configuration as that of the left stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for the right controller 4 to perform wired communication with the main body apparatus 2.

FIG. 6 is a block diagram showing an example of the internal configuration of the main body apparatus 2. The main body apparatus 2 includes components 81 to 91, 97, and 98 shown in FIG. 6 in addition to the components shown in FIG. 3. Some of the components 81 to 91, 97, and 98 may be mounted as electronic components on an electronic circuit board and housed in the housing 11.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) stored in a storage section (specifically, an internal storage medium such as a flash memory 84, an external storage medium attached to the slot 23, or the like), thereby performing the various types of information processing.

The main body apparatus 2 includes the flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing. The processor 81 appropriately reads and writes data from and to the storage media such as the flash memory 84 and the DRAM 85 to execute various types of information processing. In the exemplary embodiment, the “memory” may include at least a flash memory and a DRAM and may also include other storage media.

The main body apparatus 2 includes a slot interface (hereinafter, abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined method for communication (e.g., communication based on a unique protocol or infrared light communication). The wireless communication in the above second communication form achieves the function of enabling so-called “local communication” in which the main body apparatus 2 can wirelessly communicate with another main body apparatus 2 placed in a closed local network area, and the plurality of main body apparatuses 2 directly communicate with each other to transmit and receive data.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2, and the left controller 3 and the right controller 4, is discretionary. In the exemplary embodiment, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the stationary monitor or the like via the cradle.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of players can simultaneously provide inputs to the main body apparatus 2, each using a set of the left controller 3 and the right controller 4. As an example, a first player can provide an input to the main body apparatus 2 using a first set of the left controller 3 and the right controller 4, and simultaneously, a second player can provide an input to the main body apparatus 2 using a second set of the left controller 3 and the right controller 4.

The main body apparatus 2 includes a touch panel controller 86, which is a circuit for controlling the touch panel 13. The touch panel controller 86 is connected between the touch panel 13 and the processor 81. On the basis of a signal from the touch panel 13, the touch panel controller 86 generates data indicating the position at which a touch input has been performed, for example, and outputs the data to the processor 81.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). On the basis of a command from the processor 81, the power control section 97 controls the supply of power from the battery 98 to the above components.

Further, the battery 98 is connected to the lower terminal 27. When an external charging device (e.g., the cradle) is connected to the lower terminal 27 and power is supplied to the main body apparatus 2 via the lower terminal 27, the battery 98 is charged with the supplied power.

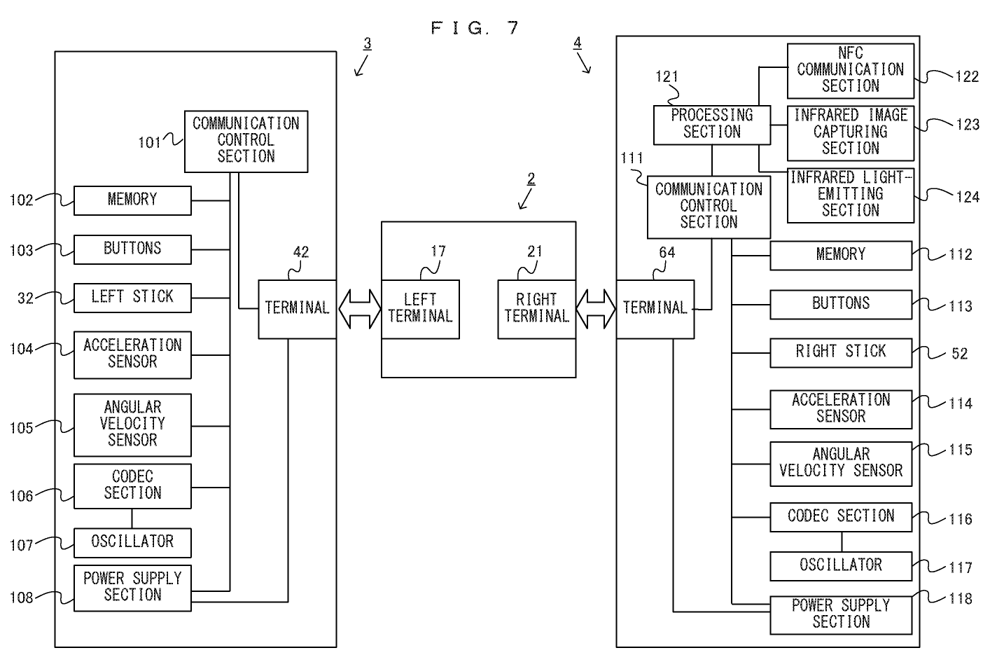

FIG. 7 is a block diagram showing examples of the internal configurations of the main body apparatus 2, the left controller 3, and the right controller 4. The details of the internal configuration of the main body apparatus 2 are shown in FIG. 6 and therefore are omitted in FIG. 7.

The left controller 3 includes a communication control section 101, which communicates with the main body apparatus 2. As shown in FIG. 7, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the left stick 32. Each of the buttons 103 and the left stick 32 outputs information regarding an operation performed on itself to the communication control section 101 repeatedly at appropriate timings.

The left controller 3 includes inertial sensors. Specifically, the left controller 3 includes an acceleration sensor 104. Further, the left controller 3 includes an angular velocity sensor 105. In the exemplary embodiment, the acceleration sensor 104 detects the magnitudes of accelerations along predetermined three axial (e.g., x, y, z axes shown in FIG. 4) directions. The acceleration sensor 104 may detect an acceleration along one axial direction or accelerations along two axial directions. In the exemplary embodiment, the angular velocity sensor 105 detects angular velocities about predetermined three axes (e.g., the x, y, z axes shown in FIG. 4). The angular velocity sensor 105 may detect an angular velocity about one axis or angular velocities about two axes. Each of the acceleration sensor 104 and the angular velocity sensor 105 is connected to the communication control section 101. Then, the detection results of the acceleration sensor 104 and the angular velocity sensor 105 are outputted to the communication control section 101 repeatedly at appropriate timings.

The communication control section 101 acquires information regarding an input (specifically, information regarding an operation or the detection result of the sensor) from each of input sections (specifically, the buttons 103, the left stick 32, and the sensors 104 and 105). The communication control section 101 transmits operation data including the acquired information (or information obtained by performing predetermined processing on the acquired information) to the main body apparatus 2. The operation data is transmitted repeatedly, once every predetermined time. The interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the left stick 32 on the basis of the operation data. Further, the main body apparatus 2 can calculate information regarding the motion and/or the orientation of the left controller 3 on the basis of the operation data (specifically, the detection results of the acceleration sensor 104 and the angular velocity sensor 105).

The left controller 3 includes a vibrator 107 for notifying a user by vibration. In the exemplary embodiment, the vibrator 107 is controlled by a command from the main body apparatus 2. That is, when the communication control section 101 receives the above command from the main body apparatus 2, the communication control section 101 drives the vibrator 107 according to this command. Here, the left controller 3 includes a codec section 106. When the communication control section 101 receives the above command, the communication control section 101 outputs a control signal corresponding to the command, to the codec section 106. The codec section 106 generates a drive signal for driving the vibrator 107 from the control signal from the communication control section 101 and provides the drive signal to the vibrator 107. Accordingly, the vibrator 107 operates.

The vibrator 107 is more specifically a linear vibration motor. Unlike a normal motor that performs rotational motion, the linear vibration motor is driven in a predetermined direction according to an inputted voltage and thus can be vibrated at an amplitude and a frequency corresponding to the waveform of the inputted voltage. In the exemplary embodiment, the vibration control signal transmitted from the main body apparatus 2 to the left controller 3 may be a digital signal representing the frequency and the amplitude per unit time. In another exemplary embodiment, information indicating the waveform itself may be transmitted from the main body apparatus 2, but by transmitting only the amplitude and the frequency, the amount of communication data can be reduced. In addition, in order to further reduce the amount of data, only the differences from the previous values may be transmitted instead of the values of the amplitude and the frequency at that time. In this case, the codec section 106 converts the digital signal indicating the amplitude and frequency values acquired from the communication control section 101 into an analog voltage waveform and drives the vibrator 107 by inputting a voltage in accordance with this waveform. Therefore, the main body apparatus 2 can control the amplitude and the frequency for vibrating the vibrator 107 at that time, by changing the amplitude and the frequency transmitted per unit time. Each of the amplitude and the frequency transmitted from the main body apparatus 2 to the left controller 3 is not limited to one, and two or more amplitudes and two or more frequencies may be transmitted. In that case, the codec section 106 can generate a waveform of the voltage for controlling the vibrator 107 by synthesizing the waveforms that are indicated by the received multiple amplitudes and frequencies, respectively.

The left controller 3 includes a power supply section 108. In the exemplary embodiment, the power supply section 108 includes a battery and a power control circuit. Although not shown in FIG. 7, the power control circuit is connected to the battery and also connected to components of the left controller 3 (specifically, components that receive power supplied from the battery).

As shown in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113, the right stick 52, and inertial sensors (an acceleration sensor 114 and an angular velocity sensor 115). These input sections have functions similar to those of the input sections of the left controller 3 and operate similarly to the input sections of the left controller 3.

The right controller 4 also includes a vibrator 117 and a codec section 116. The vibrator 117 and the codec section 116 operate in the same manner as the vibrator 107 and the codec section 106 of the left controller 3. That is, the communication control section 111 operates the vibrator 117, using the codec section 116, according to a command from the main body apparatus 2.

The right controller 4 includes a power supply section 118. The power supply section 118 has a function similar to that of the power supply section 108 of the left controller 3 and operates similarly to the power supply section 108.

### Outline of game processing in exemplary embodiment

Next, the outline of operation of game processing executed by the game system 1 according to the exemplary embodiment will be described. In the following description, the left controller 3 and the right controller 4 are collectively referred to simply as “controller”.

### Assumed game

Next, a game assumed in the exemplary embodiment will be described. In the game assumed in the exemplary embodiment, the user can freely place various objects within a three‑dimensional virtual space (hereinafter simply referred to as virtual space) to create a virtual town space (hereinafter referred to as virtual town). In this example, a virtual “island” is prepared within the virtual space, and the user can create the virtual town on this island. Examples of objects that can be placed include building‑type objects (hereinafter simply referred to as building) and decoration‑type objects (hereinafter referred to as decorations). Examples of buildings include detached houses, apartment buildings, and shops. Examples of decorations include roads, street trees, potted plants, streetlights, and traffic signals. By performing predetermined operations on a predetermined edit screen, the user can place these objects at desired positions on the island. In addition, as for buildings, the user may be allowed not only to use buildings prepared in advance but also to create and edit appearances thereof. For example, a “building editor” function may be implemented. Although details will be described later, building‑type objects are further classified into multiple types.

Furthermore, in this game, the user can create virtual residents and place the virtual residents within the above virtual town. The appearance of each virtual resident can also be created and edited by the user. Each placed virtual resident acts autonomously and leads a virtual life. That is, the user can create virtual residents and allow the virtual residents to live in the virtual town.

Here, each virtual resident is provided with a parameter referred to as a “human relationship parameter”, and virtual human relationships are constructed among the virtual residents. Examples of these human relationships include strangers, acquaintances, friends, romantic partners, married couples, and parent‑child relationships. Based on these human relationships, various events (such as conversations and mini-skits) occur between the virtual residents.

As described above, this game is a game in which the user creates a virtual town, places virtual residents within the virtual town, and observes how each virtual resident lives within the town.

### Camera mode

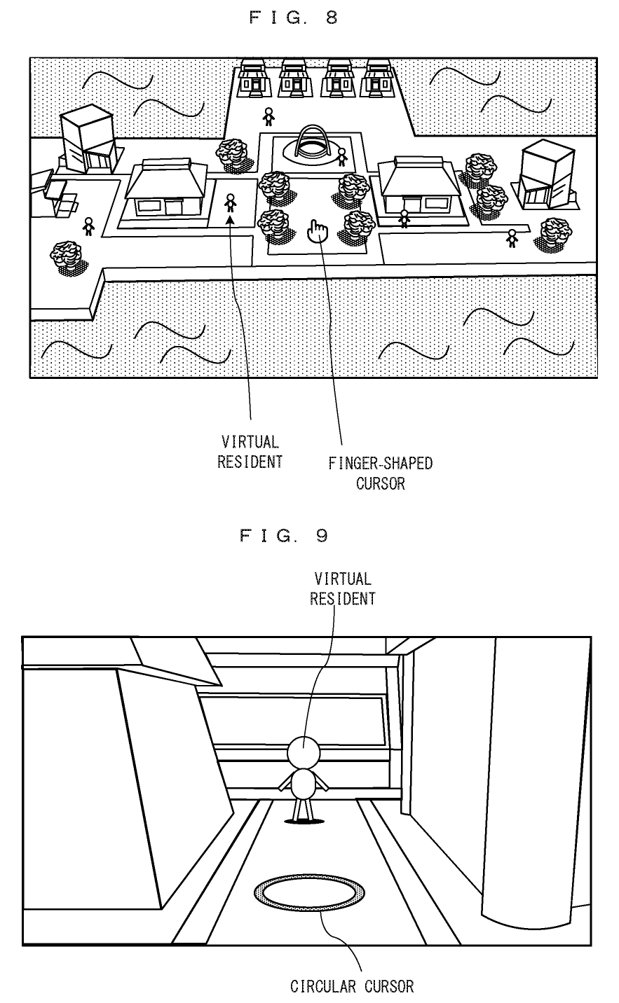

Next, screen examples of this game and modes of a virtual camera will be described. FIGS. 8 and 9 show screen examples of this game. First, the screen example of FIG. 8 will be described. FIG. 8 illustrates a game screen based on an overhead viewpoint as if looking down on the virtual town from above. Within the game screen, a finger‑shaped cursor and multiple virtual residents are displayed. The finger‑shaped cursor also serves as a substantial object to be operated by the user. To describe this point more precisely, in this game, an invisible point referred to as a “reference point” is provided, and the object to be operated directly by the user is this reference point. Specifically, the user changes the X‑coordinate and the Z‑coordinate of the reference point in the virtual space by operating the left stick 32. No collision detection may be performed, and the reference point may be movable along the ground surface of the virtual town, for example. Alternatively, when a building object in the virtual town overlaps the X‑coordinate and the Z‑coordinate of the reference point, the Y‑coordinate of the reference point may be determined such that the reference point is positioned higher than the building object. Alternatively, the reference point may be moved on the XZ plane of the virtual space at a predetermined height from the ground surface of the virtual town. In this example, a case where the reference point is moved along the ground surface of the virtual town will be described. The gazing point of the virtual camera and the position of the finger‑shaped cursor (and the position of a circular cursor described later) are determined individually based on the position of the reference point. In this game, the position of the reference point, the position of the gazing point, and the position of the finger‑shaped cursor are set to nearly the same position. That is, control is performed in which the reference point is positioned near the center of the game screen, the gazing point of the virtual camera is also located at the center of the screen, and the finger‑shaped cursor is also displayed at the center of the screen. Therefore, in this game, when the left stick 32 is operated, the virtual camera is moved in a state where the finger‑shaped cursor is always displayed at the center of the game screen, thereby providing the user with an operational feel as if the user was moving the finger‑shaped cursor (user’s viewpoint) in the air above the virtual town.

The positions of the reference point, the gazing point, and the finger‑shaped cursor (and the circular cursor described later) do not necessarily have to coincide at all times. The position of the reference point, the position of the gazing point, and the position of the finger‑shaped cursor may temporarily differ from each other. In the case where control is performed in which, for example, when the reference point is moved rapidly, the virtual camera follows the reference point with slight delay in order to avoid abrupt viewpoint changes, the positions of the reference point and the gazing point may temporarily deviate from each other (eventually, the positions of the reference point and the gazing point are controlled to coincide). Additionally, control may be performed in which, for example, when the finger‑shaped cursor is aligned with a predetermined virtual resident, the finger‑shaped cursor is fixed to (locked onto) the virtual resident and the virtual camera is caused to automatically follow the virtual resident. In this case, depending on the position of the virtual resident, the position of the finger‑shaped cursor may slightly deviate from the reference point.

Next, the screen example of FIG. 9 will be described. FIG. 9 shows a game image as seen from a viewpoint close to the eye level of a virtual resident, near the ground surface of the virtual town. Therefore, compared to the game image in FIG. 8 above, it is possible to move within the virtual town at the eye level of a virtual resident, thereby providing a game image having greater realism. In addition, in FIG. 9, a circular cursor is displayed in place of the finger‑shaped cursor. In the following description, the above finger‑shaped cursor and the circular cursor are sometimes collectively referred to simply as “cursor”. In this screen as well, an invisible reference point is provided as in the above, and the position of the virtual camera, the position of the gazing point, and the position of the circular cursor are determined based on this reference point. Therefore, the user visually perceives an operational feel as if operating the circular cursor. Specifically, the user changes the X‑coordinate and the Z‑coordinate of the reference point in the virtual space by operating the left stick 32. In addition, in this screen, a raycast is performed from the reference point toward the ground, and the Y‑coordinate of the reference point is determined such that the reference point is positioned slightly above the ground.

### Control of gazing point in FIG. 9

The X‑coordinate and the Z‑coordinate of the gazing point in the game screen in FIG. 9 are set to the same coordinates as those of the reference point, and the Y‑coordinate of the gazing point is set such that the position of the gazing point becomes the most stable position based on the history of the Y‑coordinate of the reference point. Specifically, when the Y‑coordinate of the reference point has not changed for a while, or when the reference point moves from a lowland area to a highland area, the Y‑coordinate of the gazing point is set to the same Y‑coordinate as that of the reference point. On the other hand, when the reference point moves from a highland area to a lowland area, the Y‑coordinate of the gazing point is not updated. Accordingly, even when the reference point is moved in terrain where the height of the reference point tends to fluctuate, camera control can be performed without causing the gazing point to shake significantly. In this example, the circular cursor is placed at a position obtained by projecting the reference point vertically onto the ground surface, that is, the circular cursor is placed so as to lie along the ground surface. Alternatively, the circular cursor may be placed at a position offset in the Y‑direction from the ground surface. Thus, in such a case, the gazing point and the cursor position do not coincide (the positions of both are determined based on the reference point).

Next, the position and the orientation of the virtual camera in the above two screens will be described. FIG. 10 schematically illustrates the virtual camera in each of the above two screens. For convenience of description, in the following description, (the camera mode of) the virtual camera at the overhead viewpoint as shown in FIG. 8 above is referred to as “overhead camera”, and (the camera mode of) the virtual camera at the viewpoint as shown in FIG. 9 above is referred to as “ground camera”.

In this game, as an example, the overhead camera is positioned at a distance of “120” from the reference point with a depression angle of 30°. Meanwhile, the ground camera is positioned closer to the ground surface of the virtual town compared to the overhead camera, and is located at a distance of “6” from the reference point with a depression angle of 8.5°. In addition, the position of the ground camera is determined based on a relative position from the gazing point. In this game, it is possible to switch between the “overhead camera” and the “ground camera” by operating the right stick 52 in the up-down direction. That is, when the right stick 52 is tilted to input the “up direction” at the time of the overhead camera, the virtual camera switches to the ground camera. At this time, the switching may occur instantly, or a representation in which the virtual camera gradually moves from the position of the overhead camera to the position of the ground camera may be inserted. In addition, when the right stick 52 is tilted to input the “down direction” at the time of the ground camera, the virtual camera can be switched from the ground camera to the overhead camera. In this case as well, the switching may occur instantly, or a representation in which the virtual camera gradually switches from the ground camera to the overhead camera may be inserted.

Moreover, the user can move the virtual camera along an orbital path around the reference point without changing the gazing point, by an input of the right stick 52 in the left-right direction.

Meanwhile, in this game, an object that is within the field of view of the virtual camera and within a predetermined range from the virtual camera is subjected to a transparency process. Specifically, when a disk‑shaped collision area centered on the virtual camera comes into contact with a collision area of the object, the object is made transparent. In the exemplary embodiment, a process of gradually increasing the transparency of the object over time until the object becomes completely transparent (hereinafter referred to as alpha‑out) is performed. By increasing transparency over time, sudden disappearance or reappearance of buildings is prevented. This alpha‑out process is adopted in consideration of the nature of this game in which virtual residents are observed. As described above, in this game, the user can freely place buildings, etc. Depending on how buildings are placed, narrow streets or alleys may be formed. Meanwhile, in particular, the above ground camera is positioned near the ground surface with a low depression angle. Therefore, contact between the virtual camera and objects such as buildings is likely to occur. Here, as control performed when contact between the virtual camera and an object such as a building occurs, it is conceivable to perform control of pushing the virtual camera away. However, with such control, the following situation may occur, for example, if an attempt to cause the virtual camera to enter a narrow path so as to follow a virtual resident having entered the narrow path is made: the virtual camera is blocked by a building and fails to enter the narrow path, thereby making it impossible to observe the virtual resident. In view of this, in this game, ensuring that virtual residents remain observable is prioritized, and control is performed in which various objects such as buildings and decorations that appear directly in front of the virtual camera are made transparent and the position of the virtual camera is left unchanged. As a modification, in addition to preparing a collision area for the camera, a raycast may be performed from the camera in an XZ component direction for a fixed distance, and any intersecting objects may be made transparent.

Objects to be made transparent are various objects located very close within the field of view of the virtual camera and include not only buildings and decorations but also virtual residents themselves. The distance at which the transparency process is started may differ between virtual residents and other various objects. For example, the distance at which the transparency process is started may be shorter for virtual residents than for buildings, etc. This is because delaying the timing of the transparency process for virtual residents better matches the nature of the game in which virtual residents are observed.

Next, “access” to buildings will be described. As for the above buildings, the building can be accessed through a predetermined operation (hereinafter, this is referred to as building access). When building access is performed, a predetermined process corresponding to the building (hereinafter referred to as building access process) is executed. The building access process will be described later, and, for example, a process of entering the building (moving to a different area corresponding to the interior of the building, in the virtual space), a process of displaying a shop screen, or the like is performed. In this game, a method for performing the building access differs between the case of the overhead camera and the case of the ground camera.

### Building access method at time of overhead camera

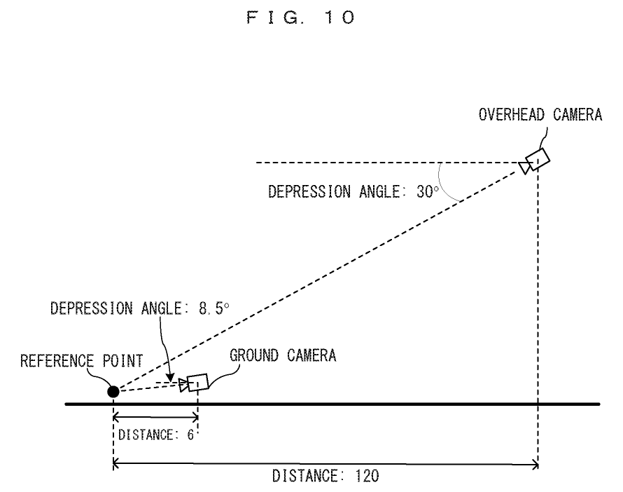

First, building access in the case of the overhead camera will be described. In this case, as shown in FIG. 11, in a state where the finger‑shaped cursor overlaps a predetermined building, building access can be performed for the building by pressing the A-button 53.

In this game, when the finger‑shaped cursor overlaps a building, a “popup label” serving as a label that indicates the name of the building is also displayed as shown in FIG. 11. The display of the popup label will be described later.

### Building access method at time of ground camera

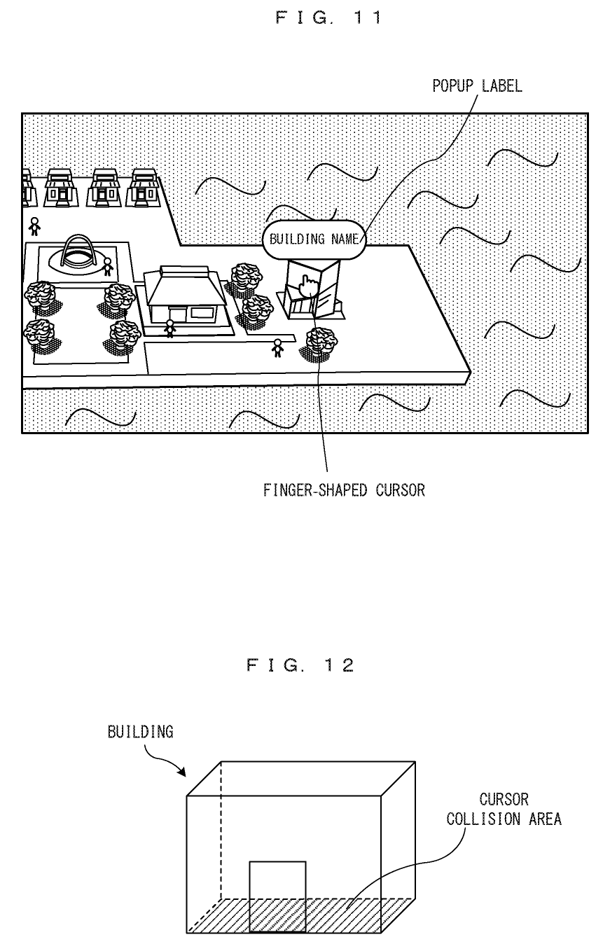

Next, building access in the case of the ground camera will be described. In this case, control is performed such that the circular cursor cannot move into buildings. Specifically, in this example, a “cursor collision area” shown in FIG. 12 is provided for each building. In the case of the ground camera, the circular cursor is controlled such that the circular cursor cannot enter the cursor collision area. Additionally, the reference point cannot move toward the cursor collision area when the circular cursor centered on the XZ‑coordinate of the reference point comes into contact with the cursor collision area. Thus, in actuality, the reference point cannot be moved from a position slightly away from the cursor collision area toward the cursor collision area. The cursor collision area is set for each building having a certain size. Accordingly, by setting the gazing point at the center of a building having a wide area, a game screen in which a building that is supposed to be hidden is displayed in a large size can be prevented from being generated. The shape of this collision area may be any shape, and an area on the ground surface corresponding to the lot of the building may be set as the cursor collision area. Moreover, for example, when the shape of a building is an octahedron, a sphere, or an egg shape, the collision area of the building may be moved closer to the ground surface, and an area overlapping the ground surface may be set as the cursor collision area. As a modification, regardless of the sizes of buildings, the cursor collision area may be applied to specific types of buildings.

When performing building access in the case of the ground camera, an “access area” set for each building is used. FIG. 13 shows an example of the access area. In FIG. 13, a predetermined area on a two‑dimensional plane in front of an entrance of a building is set as the access area. In addition, although illustrated in FIG. 13, the access area is invisible in a game image. In the exemplary embodiment, the access area is set such that the access area does not overlap the cursor collision area.

In another example, a part of the access area may overlap the cursor collision area. Furthermore, in this example, the access area is illustrated as an area on a two‑dimensional plane, but in another exemplary embodiment, the access area may be set as a space (access space) having a height.

By pressing the A-button 53 in a state where the circular cursor is within the access area, building access can be performed to the building corresponding to the access area. Moreover, in the case of the ground camera, when the circular cursor is within the access area, a popup label as shown in the case of the overhead camera is displayed as appropriate.

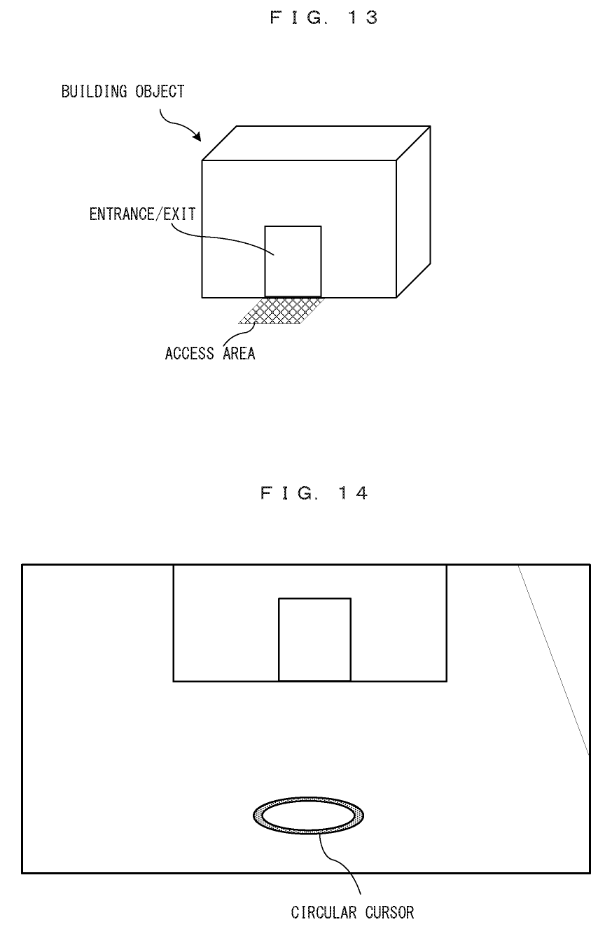

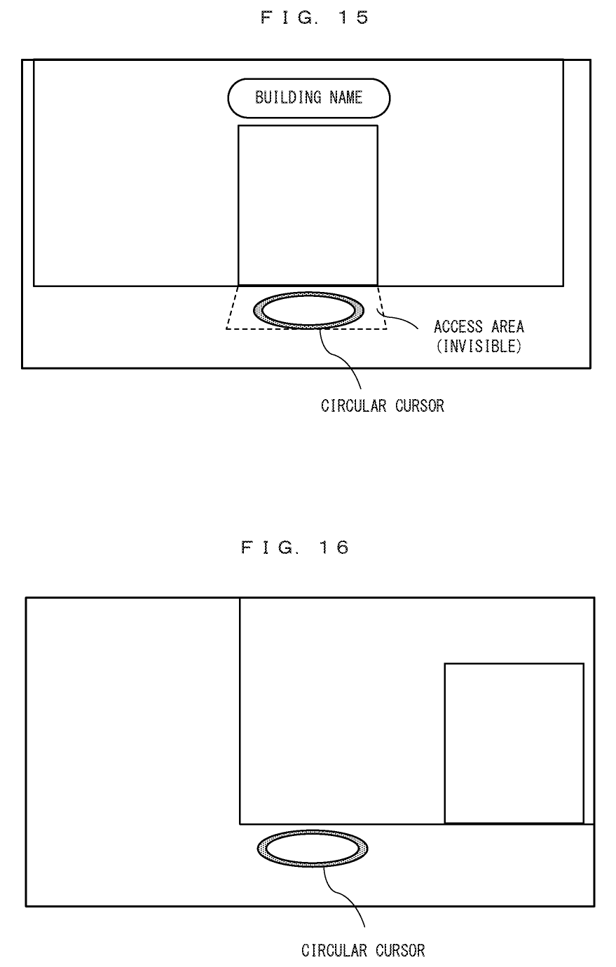

A specific example of building access in the case of the ground camera will be described using screen examples. FIG. 14 illustrates a screen example showing a state where the circular cursor is positioned at some distance away from a building. In FIG. 14, the building is present in the front direction. From the state in FIG. 14, movement is made in the front direction, reaching a state in FIG. 15, that is, a state where the circular cursor is positioned just in front of an entrance of the building (within the access area). In this state, due to the presence of the cursor collision area, the circular cursor cannot be moved further in the front direction. At the same time, the circular cursor is within the access area. Therefore, by pressing the A-button 53 in this state, building access can be performed to this building.

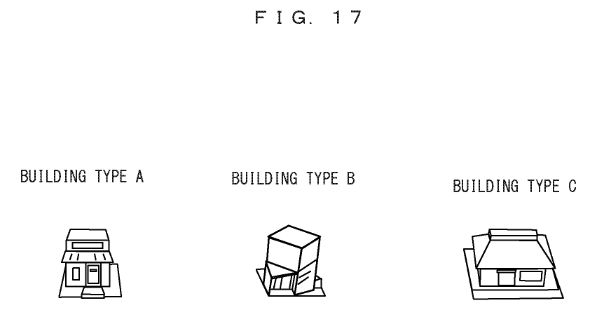

Moreover, for example, when the circular cursor is positioned adjacent to the building but is outside the access area as shown in FIG. 16, building access cannot be performed even if the A-button 53 is pressed. Furthermore, even if an attempt to move in the front direction is made in this state, the circular cursor cannot be moved in the front direction due to the presence of the cursor collision area.

Here, if an operation for switching to the ground camera is performed when the finger‑shaped cursor overlaps a building (i.e., when access is possible) at the time of the overhead camera, a game image in which the circular cursor is placed inside the building (within the cursor collision area) may be displayed as an exception. If, in such a case, for example, the circular cursor is moved to be outside the cursor collision area, there is a possibility the user may be provided with a sense of discomfort for an operation performed by the user, for example, the user may feel that the cursor moves on its own. Therefore, in such a case, the camera is switched to the ground camera such that the position of the cursor is not changed. In addition, such a camera mode switching operation is not treated as building access. Moreover, building access cannot be performed even if the A-button 53 is pressed at this time. Therefore, for example, as a result of being switched to the ground camera, the virtual camera may be positioned inside the building, the walls or roof may be made transparent by the alpha‑out control, and a game image showing an outside view may be displayed. In this state, when moving the circular cursor out of the building, the cursor collision area is temporarily disabled, allowing the circular cursor to move to the outside. However, once the circular cursor is moved to the outside, it is made impossible for the circular cursor to move into the building, by the cursor collision area (i.e., backflow is prevented).

Additionally, when an operation for rotating the virtual camera is performed through a left–right input of the right stick 52, it is also conceivable that only the virtual camera is positioned inside the building. In this case, a game screen in which the building disappears in a large area is not displayed, and thus it is acceptable to make the building transparent through the alpha‑out control.

### Process content of building access

Next, examples of processes executed when the above-described building access is performed will be described. In this game, the above buildings are classified into several “types”, and the content of the building access process differs for each type. As an example, in this game, description will be given with an example in which the buildings shown in FIG. 8 above are classified into three types. Specifically, description will be given with an example in which the buildings shown in FIG. 8 above are classified into three types: “building type A”, “building type B”, and “building type C” as shown in FIG. 17.

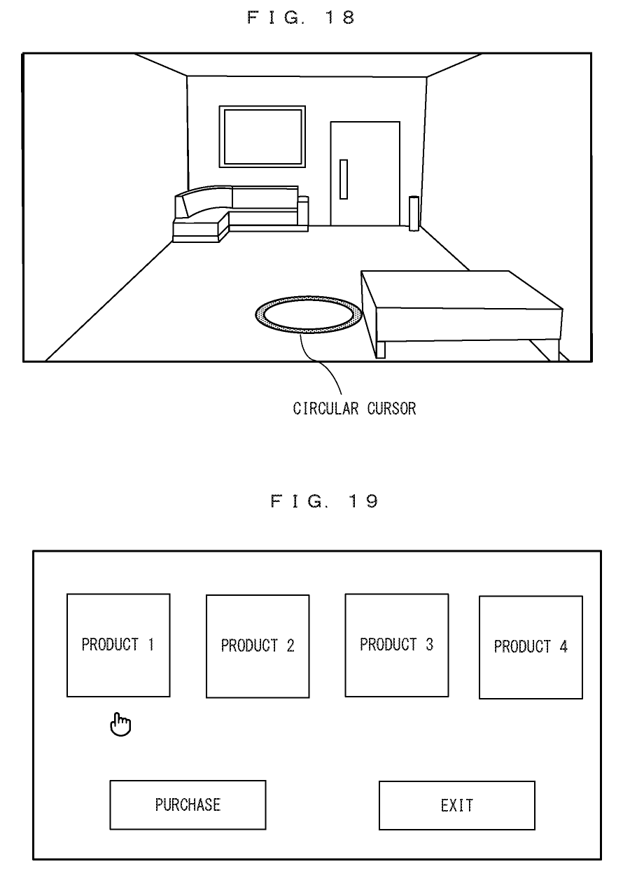

The “building type A” is assumed to be buildings that are residences for virtual residents, such as condominiums or standalone houses. The building access process for a building belonging to the “building type A” (hereinafter referred to as A‑type building) is a process of moving the reference point, the cursor, and the virtual camera to a different area corresponding to the interior of the building (hereinafter referred to as building interior area). The building interior area corresponds, for example, to a “room” inside the building, as shown in FIG. 18. That is, when building access is performed to the A‑type building, a process of entering (transitioning into) the interior of the building is performed. When movement to a different area is made as described above, a spacious room can be created regardless of the actual size of the building in the virtual town. The camera mode of the virtual camera inside the building is controlled such that the camera mode is fixed to the above “ground camera” or a building interior-dedicated mode in which a depression angle or the like is set to be dedicated for building interior. In the area corresponding to the interior of the building, the reference point (and accordingly the gazing point and the cursor) can be moved within the building through the same operation as described above. By performing a predetermined operation for exiting (e.g., aligning the cursor with an exit and pressing the A-button 53), the building interior area can be exited.

The “building type B” is assumed to be buildings where items can be purchased and sold, such as shops. The building access process for a building belonging to the “building type B” (hereinafter referred to as B‑type building) is a process of switching to a “shop screen”, for example, as shown in FIG. 19 and purchasing or selling an item in accordance with an operation performed by the user. In addition, the shop screen is closed when an exit operation is performed.

The “building type C” is assumed to be buildings such as restaurants and various leisure facilities. The interior of a building belonging to the “building type C” (hereinafter referred to as C‑type building) is fully constructed unlike the “building type A” and the “building type B”. In this game, in the case of the “building type A” or the “building type B”, since movement to a different area is made or switching to a shop screen is made, the interiors of these types of buildings are substantially empty spaces. In contrast, as for the C‑type building, for example, if the building is a restaurant, the building is created with objects such as tables and chairs arranged within the lot of the building. For the C‑type building, the method of building access at the time of the overhead camera is slightly different from that for the other types. The building access to the C‑type building will be described below with reference to the drawings.

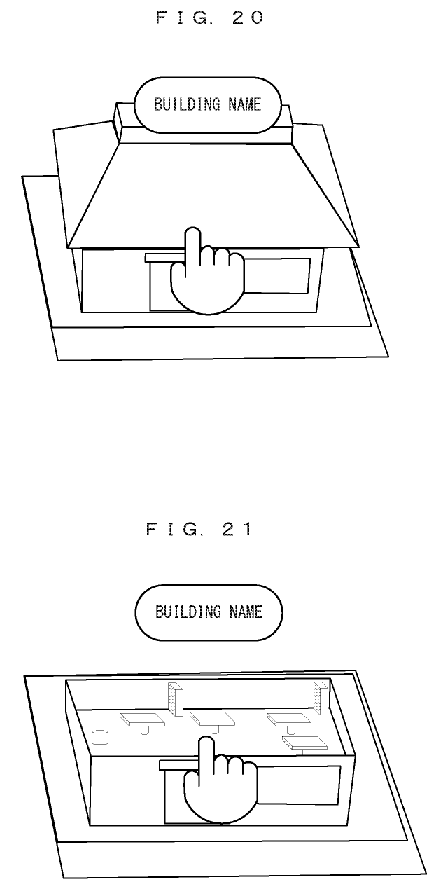

First, the behavior when performing the building access to the C‑type building in the case of the overhead camera will be described. In the state of the overhead camera, when the finger‑shaped cursor is aligned with the C‑type building, for example, a state as shown in FIG. 20 is obtained. In this state, when the user presses the A-button 53, only the “roof” of the C‑type building becomes hidden, as shown in FIG. 21. In this state, the interior of the C‑type building can be confirmed, and in the example of FIG. 21, it can be confirmed that tables, etc., are arranged.

Then, in the state shown in FIG. 21, if the user further performs an operation on the right stick 52 in the up direction (for switching to the ground camera), the virtual camera seamlessly moves into the building through an entrance of the building. Then, the virtual camera switches to the ground camera when the virtual camera reaches the position just inside the entrance of the building. That is, in the case of the overhead camera, for the C‑type building, building access is performed through either an operation of an upward input of the right stick 52 or a two-step operation of hiding the roof with the A-button 53 and then pressing the A-button 53. After entering the interior of the building, it is possible to move around inside the building as in the case of the above “building type A”. In addition, if an operation for exiting the building is performed, the camera returns to the overhead camera.

Meanwhile, in the case of the ground camera, the above two‑step process is not performed, and building access can be performed to the C‑type building via the above “access area” as in the case of the other types of buildings. As for movement into the interior of the building, the cursor collision area may be temporarily disabled, allowing the cursor and the virtual camera to move seamlessly into the interior of the building (near the entrance). Alternatively, without disabling the cursor collision area, screen switching may be inserted before the cursor, etc., are moved into the interior of the building.

Additionally, when the virtual camera is within the C‑type building, the above alpha‑out control may be temporarily disabled. Alternatively, only when the virtual camera is within the C‑type building, the distance at which the transparency process is started may be changed to a shorter distance.

From the viewpoint of whether or not a screen transition occurs, the above various types of buildings can be categorized into two types, that is, the A‑type building and the B‑type building can be regarded as a “screen‑transition‑type building” which involves a transition to a different screen, and the C‑type building can be regarded as a “seamless‑type building” the interior of which can be moved seamlessly into.

### Pick function

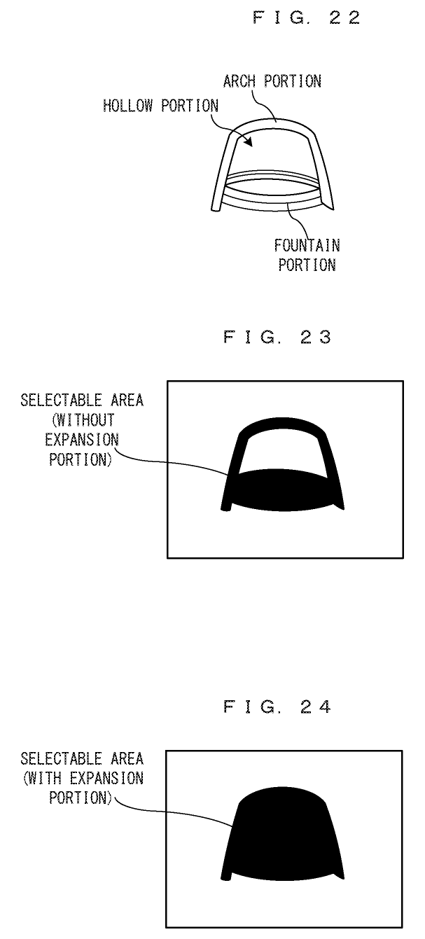

Next, processing related to a pick function using a frame buffer (hereinafter simply referred to as pick function) will be described. First, the outline and principle of the pick function will be described. For example, a building shaped as shown in FIG. 22 is assumed. The building shown in FIG. 22 is a building belonging to the “building type B” and is modeled after a “fountain” (hereinafter referred to as fountain object). The shape of the fountain object consists of a fountain portion and an arch portion, with a hollow (empty) space existing between the arch portion and the fountain portion. When considering the pixels of the game screen in the case of the overhead camera, an area where the fountain object is rendered is as shown in FIG. 23, for example. In FIG. 23, the black portion indicates the pixels at which an image corresponding to the fountain object is rendered. In other words, the black area can be considered as a selectable area for selecting the fountain object.

Here, for example, the case where the position of the tip of the index finger of the finger‑shaped cursor is used to determine which building is specified is assumed, and the case where the fingertip of the finger‑shaped cursor is positioned in a hollow portion is assumed. In such a case, if the overlap between the finger‑shaped cursor and the fountain object is strictly determined, the finger‑shaped cursor may be treated as not selecting the fountain object. In this case, even though the user intends to select the fountain object and aligns the finger‑shaped cursor accordingly, even if the user presses the A-button 53, building access cannot be performed, so that there is a possibility of causing the user to feel a decrease in operability.

Therefore, in this game, control is performed such that building access is possible even when the finger‑shaped cursor is not strictly overlapping the building. Accordingly, the operational feel can be improved. Specifically, in this example, for each pixel of the game image, information defined as information indicating a building corresponding to each pixel (hereinafter referred to as pick information) is used. This information may be embedded as additional information for each pixel in a frame buffer, for example. For the pixel at a position indicated by the finger‑shaped cursor, this information is referred to, and it is determined whether there is a building associated with this pixel. If there is an associated building, control is performed such that building access to this building is made possible.

As the pick information, information indicating a building to be rendered at a certain pixel is basically set. However, for a building such as the fountain object described above, information of the fountain object is also associated with pixels at which, strictly speaking, the fountain object is not rendered. In the above case, as shown in FIG. 24, pick information with which the information of the fountain object is associated is also set for pixels at which a hollow portion is rendered. In FIG. 24 as well, the black portion indicates a selectable area. That is, an area wider than a pixel range (see FIG. 23) where the object is actually rendered is set as the selectable area. By expanding the selectable area, it becomes easier to select the desired building. In the following, of the selectable area, a pixel portion where the corresponding building is not rendered is sometimes referred to as “expansion portion”.

When determining the building selected by the finger‑shaped cursor, it is possible to reflect the selection intended by the user, by referring to this pick information. In the above example, when the finger‑shaped cursor is pointing at the hollow portion (i.e., the expansion portion), the pixel indicated by the finger‑shaped cursor is associated with the fountain object according to the pick information. Therefore, if the A-button 53 is pressed in this state, control in which a process of performing building access to the fountain object is executed is performed.

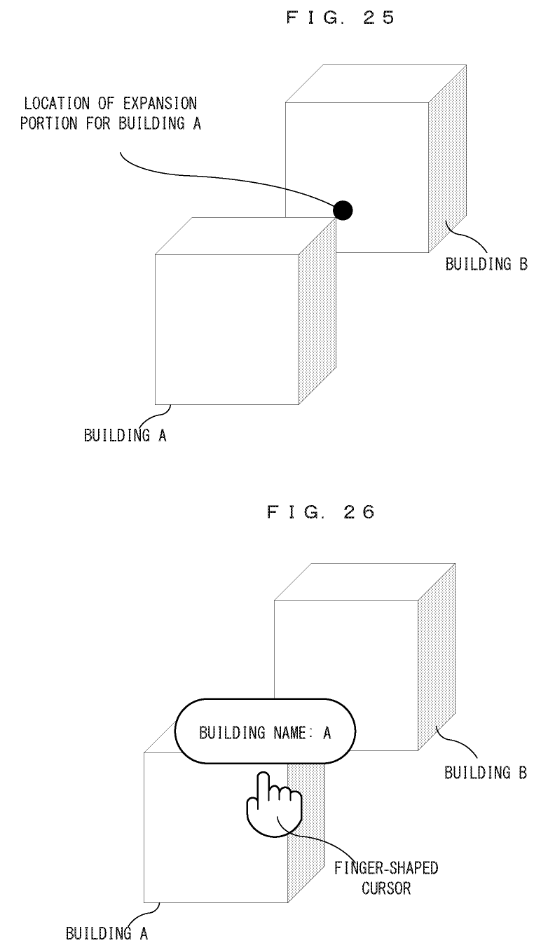

When an area wider than the pixel area where the object is actually rendered is set as the selectable area, the expansion portion may overlap the display of another building. For example, it is assumed that a building B is placed behind a building A and a selectable area for the building A is set to be wider than the actual rendered area in the pick information. In this case, as illustrated by a black‑dot position in FIG. 25, a position (expansion portion) included in the selectable area for the building A may overlap any pixel at which the building B is rendered. In such a case, if the finger‑shaped cursor is moved to the black‑dot position and the A-button 53 is pressed, the building B is preferentially selected, and a process for building access to the building B is executed. Accordingly, since the building that is actually displayed is prioritized, the sense of inconsistency between what the user sees and the executed building access is inhibited from being given, thereby making it less likely to cause confusion.

Next the display of the above popup label will be described. In this game, in the case of the overhead camera, when a predetermined building is defined in the pick information for each pixel at which the finger‑shaped cursor is displayed, a popup label showing the name or the like of the building is displayed. In other words, when the finger‑shaped cursor is within the selectable area, a popup label indicating a building corresponding to this area is displayed. This popup label is displayed, for example, at least in a part of the selectable area indicated by the pick information. As a result, the popup label can be displayed such that a part thereof overlaps the building. In particular, when the cursor is in the expansion portion, displaying the popup label allows the user to visually recognize the expansion portion, making selection easier.

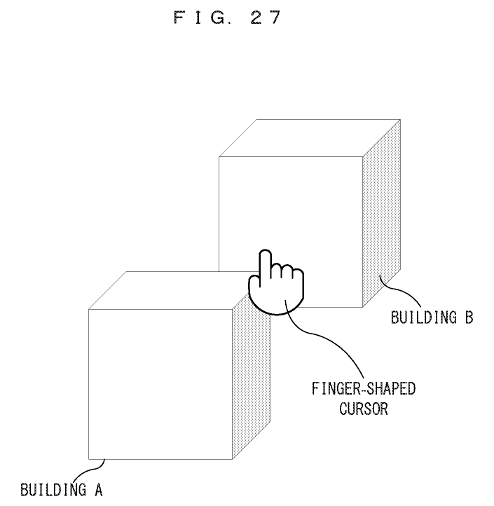

Here, as shown in FIG. 26, a popup label corresponding to the building A may be displayed, for example, in an area including the black-dot position shown in FIG. 25, that is, in the expansion portion. This state is a state where the popup label for the building A is displayed over the building B. When a building different from a building indicated by a popup label is behind the popup label as described above, if the finger‑shaped cursor is moved to a position where the building and the popup label overlap, the popup label for the building A may be deleted, for example, as shown in FIG. 27. Alternatively, the popup label for the building A may be made semi‑transparent. In other words, when a positional relationship in which a certain building, a popup label for another building, and the finger‑shaped cursor overlap is established, the popup label may be deleted. By deleting the popup label as described above, the user can determine which building the user is about to select, from the game image.

Meanwhile, in the case of the ground camera, as described above, while the circular cursor is within the access area, a popup label for the building corresponding to the access area is displayed.

### Details of game processing

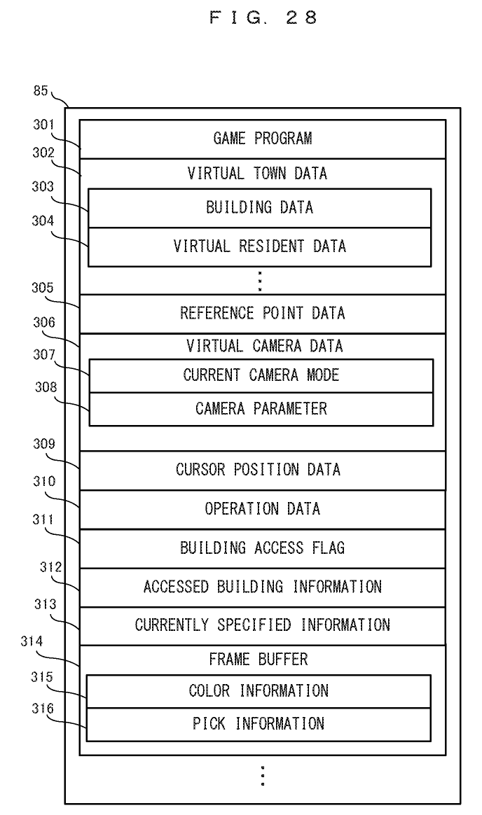

Next, the game processing in the exemplary embodiment will be described in more detail with reference to FIGS. 28 to 41. Here, the processing related to the above building access will be mainly described, and the detailed description of other game processing is omitted.

### Data to be used

First, various data to be used in the game processing will be described. FIG. 28 is a memory map showing an example of various data stored in the DRAM 85 of the main body apparatus 2. In the DRAM 85 of the main body apparatus 2, a game program 301, virtual town data 302, reference point data 305, virtual camera data 306, cursor position data 309, operation data 310, a building access flag 311, accessed building information 312, currently specified information 313, a frame buffer 314, etc., are stored.

The game program 301 is a program containing instructions that cause the processor 81 to execute the game processing described above.

The virtual town data 302 is data that defines the structure, etc., of the virtual town. This virtual town data may be generated, for example, based on operations performed by the user for placing buildings and virtual residents, on an edit screen for virtual town creation. The virtual town data 302 includes at least building data 303 and virtual resident data 304. The virtual town data 302 also includes data for the above decorations placed in the virtual town, etc.

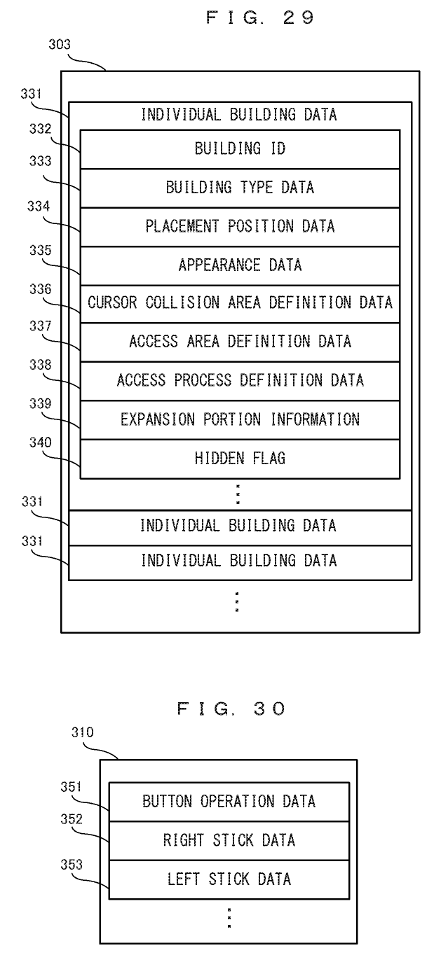

The building data 303 is data regarding various buildings placed in the virtual town. FIG. 29 illustrates an example of the data structure of the building data 303. The virtual town data 302 includes multiple individual building data 331. Each individual building data 331 includes a building ID 332, building type data 333, placement position data 334, appearance data 335, cursor collision area definition data 336, access area definition data 337, access process definition data 338, expansion portion information 339, a hidden flag 340, etc.

The building ID 332 is an ID for uniquely identifying each building placed in the virtual town.

The building type data 333 is data indicating the type of the building, in this example, any of the building types A to C.

The placement position data 334 is data indicating the position within the virtual town where the building is placed.

The appearance data 335 is data that defines the appearance of the building such as the shape and the visual features of the building and includes, for example, 3D model data, texture data, etc. For the C‑type building, data for various objects placed inside the building are also included.

The cursor collision area definition data 336 is data that defines the shape and the size of the cursor collision area for the building.

The access area definition data 337 is data that defines the position, the shape, and the size of an access area corresponding to the building.

The access process definition data 338 is data that defines the content of the process performed when the building access is performed in the case where the building is the A‑type building or the B‑type building. For example, for the A‑type building, information regarding the building interior area corresponding to the building is included. For the B‑type building, information regarding the above shop screen and items and the like that can be purchased or sold is included.

The expansion portion information 339 is data regarding the above‑described pick information and is information that indicates whether an expansion portion exists in the selectable area and is for specifying the range of the expansion portion if the expansion portion exists. For example, for a building having a hollow portion as shown in FIG. 22, information indicating that an expansion portion exists and that a hollow portion corresponds to the expansion portion, is set.

The hidden flag 340 is data used for the case where the building is the C‑type building, and is a flag for indicating whether the building is in a state where the roof of the building is hidden, as shown in FIG. 21 above. The hidden flag 340 is initially OFF, and is set to ON in a state where the roof is hidden.

Referring back to FIG. 28, the virtual resident data 304 is data regarding virtual residents placed in the virtual town. For each virtual resident, the virtual resident data 304 includes at least a resident ID used to identify the virtual resident, appearance data for the virtual resident, data indicating the current position of the virtual resident in the virtual town, and various parameters for controlling the actions of the virtual resident.

The reference point data 305 is data indicating the position of the reference point in the virtual space.

The virtual camera data 306 is data regarding the virtual camera and includes a current camera mode 307 and a camera parameter 308. The current camera mode 307 is data indicating whether the current camera mode is the overhead camera or the ground camera. Data indicating the overhead camera is initially set. The camera parameter 308 is various parameters for controlling the virtual camera. For example, the camera parameter 308 includes various parameters indicating the gazing point, the position, the imaging direction, the depression angle, the angle of view, etc., of the virtual camera.

The cursor position data 309 is data indicating the position of the above cursor and is determined based on the above reference point.

The operation data 310 is data indicating the contents of various operations performed on the controller. FIG. 30 illustrates an example of the data structure of the operation data 310. The operation data 310 includes at least button operation data 351, right stick data 352, and left stick data 353. The button operation data 351 is data indicating the contents of operations performed on the various operation buttons described above. The right stick data 352 is data indicating the contents of operations performed on the right stick 52. The left stick data 353 is data indicating the contents of operations performed on the left stick 32.

Referring back to FIG. 28, the building access flag 311 is a flag indicating whether the building access process is currently being performed for any building. The building access flag 311 is initially OFF, and when the building access flag 311 is ON, the building access flag 311 indicates that the building access process is currently being performed for any building.

The accessed building information 312 is data that is set when a predetermined building is being accessed, and information for identifying the building currently being accessed is set.

The currently specified information 313 is information that is set based on pick information 316 described later, and is information that indicates whether a building corresponding to each pixel at which the cursor is currently located exists and that is for identifying the building if the building exists.

The frame buffer 314 is a buffer area for storing the display content of a single screen to be outputted, and color information 315 and the pick information 316 are stored therein in association with each pixel. For example, in a two‑dimensional table‑format address space where a horizontal axis represents an X‑coordinate and a vertical axis represents a Y‑coordinate, the color information 315 stored at the memory address corresponding to each pixel is information indicating the rendering color for that pixel. The pick information 316 stored at each memory address is information indicating the selectable area for the building to be rendered in a game image. Specifically, the building ID 332 of the building to be rendered at each pixel is set. In addition, for some buildings, the building ID 332 may also be set as the above expansion portion for pixels at which the building is not rendered.

The above various data are merely examples. Other data may be included, or some of the data may be omitted. Furthermore, the various data do not need to exist at all times, and, for example, may be added, deleted, or modified.

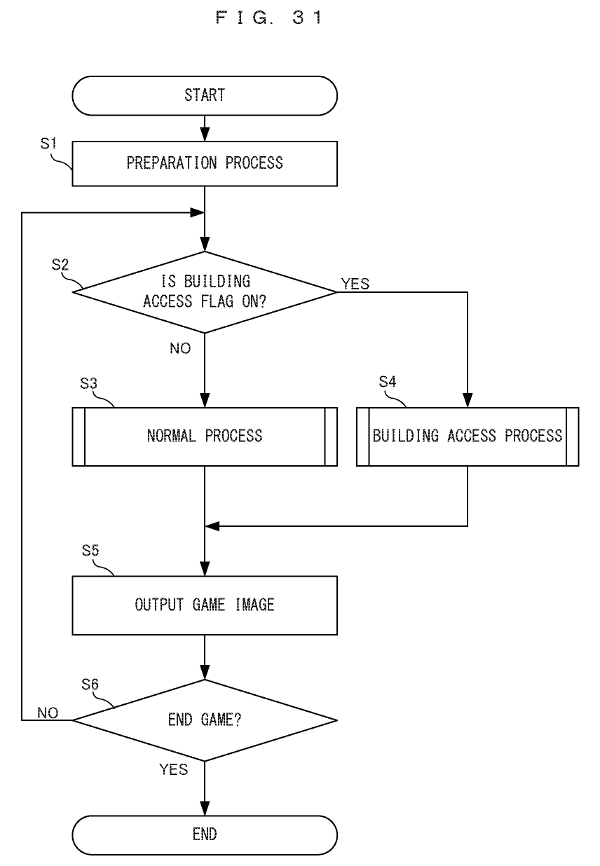

FIG. 31 is an example of a flowchart showing the processing according to the exemplary embodiment. The processing may include other processing, and part of the processing may be omitted. The order of each process is merely an example, and, for example, the processes may be executed simultaneously or in reverse order. Furthermore, the processes are described as being separated for convenience, but may be implemented as an integrated process. The following processes may also be executed at a predetermined interval (for example, per processing frame or every 1/30 seconds).

In FIG. 31, first, the processor 81 executes a preparation process (S1). In this process, a virtual town is generated based on the virtual town data 302 and placed within the virtual space. Various data are also initialized, and the reference point is placed at an initial position. Then, a game image is generated and outputted. During the generation of the game image, the above pick information 316 is also generated. A process for this generation will be described later.

Next, the processor 81 determines whether or not the building access flag 311 is ON (S2). If, as a result of the determination, if the building access flag 311 is OFF (NO in S2), the processor 81 executes a normal process (S3). On the other hand, if the building access flag 311 is ON (YES in S2), the processor 81 executes a building access process (S4).

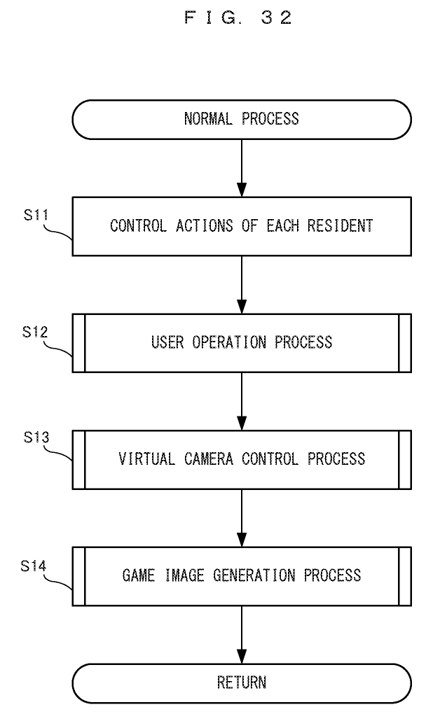

FIG. 32 is a flowchart showing the details of the normal process. In FIG. 32, first, the processor 81 controls the actions of each virtual resident (S11). Accordingly, each virtual resident moves within the virtual town or performs predetermined actions.

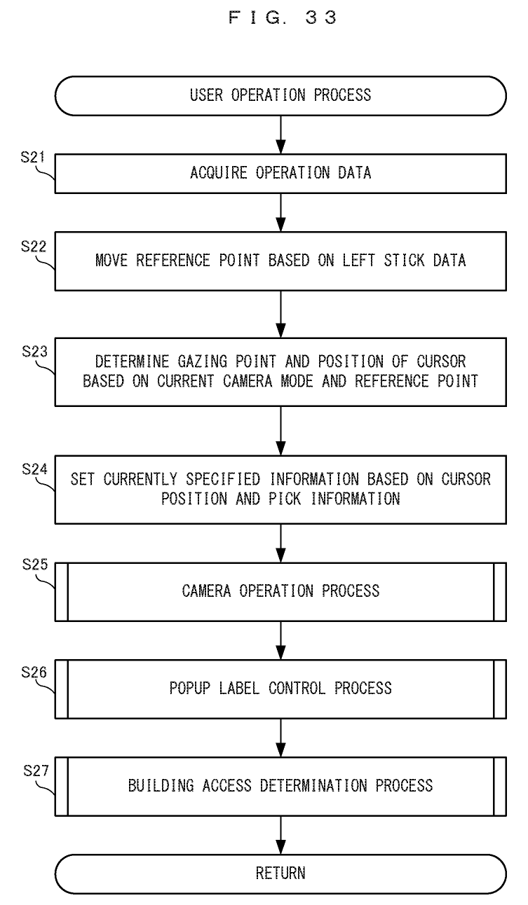

Next, the processor 81 executes a user operation process (S12). FIG. 33 is a flowchart showing the details of the user operation process. In FIG. 33, first, the processor 81 acquires operation data (S21). Next, the processor 81 sets the reference point data 305, based on the left stick data 353, and moves the position of the reference point (S22). At this time, in the case of the ground camera, the reference point is controlled such that the circular cursor does not enter the above cursor collision area. However, as described above, if the operation for switching to the ground camera is performed when the finger‑shaped cursor overlaps a building in the case of the overhead camera, the reference point may move into the cursor collision area as an exception.

Next, the processor 81 determines the position of the gazing point, based on the current camera mode 307 and the current position of the reference point, and sets a parameter regarding the gazing point in the camera parameter 308. Furthermore, the processor 81 determines the position of the cursor, based on the current camera mode 307 and the current position of the reference point, and sets the cursor position data 309 (S23). At this time, in the case of the ground camera, the gazing point and the cursor position are determined such that the circular cursor does not enter the cursor collision area as described above. However, as described above, if the operation for switching to the ground camera is performed when the finger‑shaped cursor overlaps a building in the case of the overhead camera, each position is determined such that the circular cursor is placed within the cursor collision area as an exception. Moreover, in the case of the ground camera, as described above, the Y‑coordinate of the gazing point is determined such that the position of the gazing point becomes the most stable position.

Next, the processor 81 sets the currently specified information 313, based on the current cursor position and the pick information 316 (S24). That is, if the building ID 332 of a predetermined building is set for the pixel corresponding to the current cursor position, the processor 81 sets that building ID 332 as the currently specified information 313. If no building is set for the pixel corresponding to the current cursor position, the processor 81 sets a value indicating that fact, such as a Null value, as the currently specified information 313. The process in S24 may be performed only in the case of the overhead camera and may be omitted in the case of the ground camera.

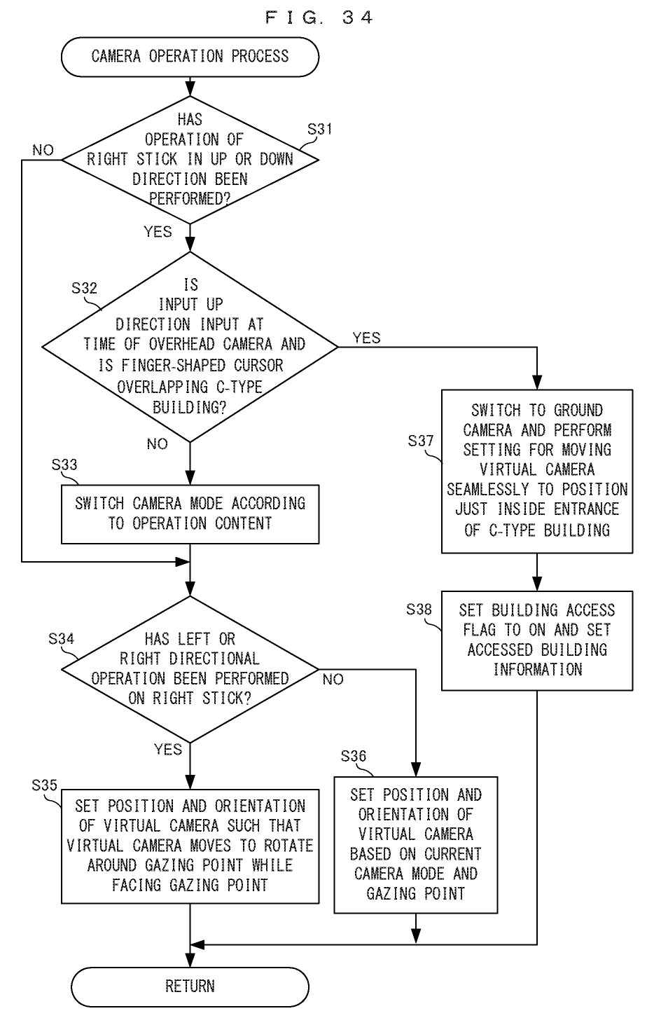

Next, the processor 81 executes a camera operation process (S25). FIG. 34 is a flowchart showing the details of the camera operation process. First, the processor 81 determines whether or not an operation of input in the up direction or the down direction on the right stick 52 has been performed, based on the right stick data 352 (S31). If, as a result of the determination, no directional input has been performed (NO in S31), the processor 81 advances the processing to S34 described later.

On the other hand, if either input operation has been performed (YES in S31), the processor 81 determines whether or not the input operation is an input in the up direction, the camera mode is the overhead camera, and the finger‑shaped cursor is overlapping a C‑type building (S32). If, as a result of the determination, this condition is not satisfied (NO in S32), the processor 81 switches the camera mode (between the overhead camera and the ground camera) based on the camera mode at that time and whether the input is an input in the up direction or an input in the down direction (S33). Additionally, along with this switching, various camera parameters (such as depression angle and position) corresponding to each camera mode are set.

Next, the processor 81 determines whether or not a left or right directional input has been performed on the right stick 52, based on the right stick data 352 (S34). If a left or right directional input has been performed (YES in S34), the position and the orientation of the virtual camera are set such that the virtual camera is moved along an orbital path around the reference point with the gazing point kept unchanged (S35). On the other hand, if no left or right directional input has been performed (NO in S34), it is considered that the right stick 52 is not being operated, and thus the processor 81 sets the position and the orientation of the virtual camera, based on the current camera mode and gazing point (S36). Then, the camera operation process ends.

On the other hand, if, as a result of the determination in S32 above, the above condition is satisfied (YES in S32), the processor 81 switches the camera mode to the ground camera. Furthermore, the processor 81 sets various parameters of the virtual camera such that the position of the virtual camera is moved seamlessly to a position just inside the entrance of the C‑type building (whose roof is hidden) that the finger‑shaped cursor is overlapping (S37).

Next, the processor 81 sets the building access flag 311 to ON and sets the building ID 332 of the C‑type building as the accessed building information 312 (S38). Then, the camera operation process ends.

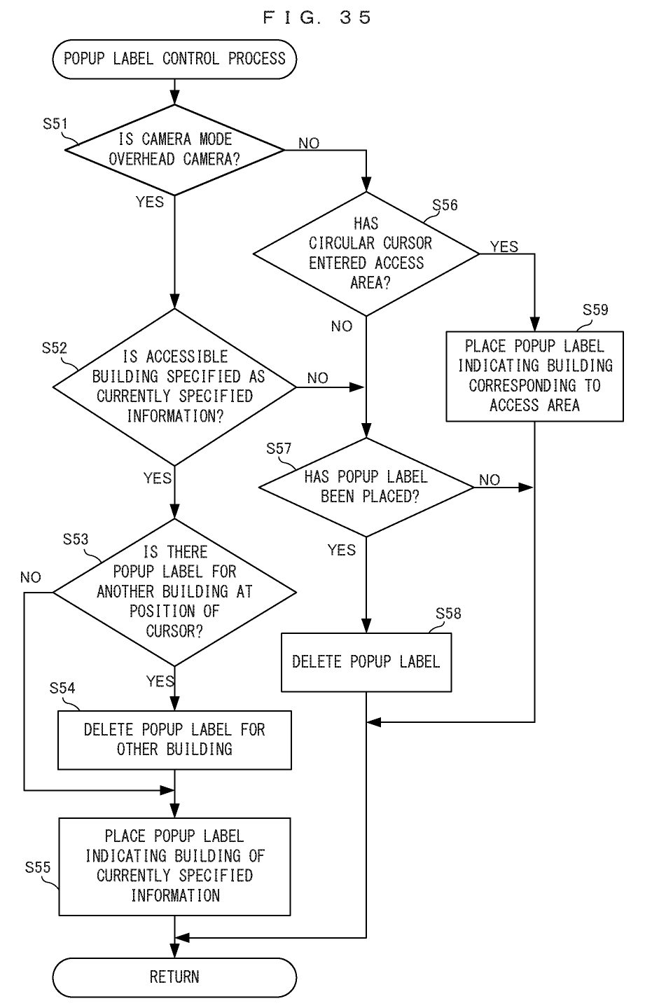

Referring back to FIG. 33, next, the processor 81 executes a popup label control process (S26). FIG. 35 is a flowchart showing the details of the popup label control process. First, the processor 81 determines whether or not the camera mode is the overhead camera (S51). If the camera mode is the overhead camera (YES in S51), next, the processor 81 determines whether or not any building ID 332 has been set as the currently specified information 313 (S52). If any building ID 332 has been set (YES in S52), the processor 81 determines whether or not a popup label indicating another building is displayed at the current position of the cursor (S53). That is, this corresponds to a case where a part of the popup label for the other building is displayed protruding outside the selectable area for the other building and overlaps the building indicated by the currently specified information 313. If, as a result of the determination, a popup label indicating another building is displayed (YES in S53), the popup label indicating the other building is deleted (S54). On the other hand, if no popup label indicating another building is displayed (NO in S53), the process in S54 is skipped.

Next, the processor 81 generates a popup label indicating the building indicated by the currently specified information 313 and places the popup label at a predetermined position (S55).

On the other hand, if, as a result of the determination in S52 above, no building ID 332 has been set as the currently specified information 313 (NO in S52), the processor 81 determines whether or not a popup label for any building has been placed (S57). If, as a result, a popup label has been placed (YES in S57), the processor 81 deletes the popup label (S58). If no popup label has been placed (NO in S57), the process in S58 is skipped. Then, the popup label control process ends.

On the other hand, if, as a result of the determination in S51 above, the camera mode is the ground camera (NO in S51), the processor 81 determines whether or not the circular cursor has entered any access area (S56). If the circular cursor has entered an access area (YES in S56), the processor 81 places a popup label indicating the building corresponding to that access area, at a predetermined position (S59). If the circular cursor has not entered any access area (NO in S56), the processor 81 advances the processing to S57 above.

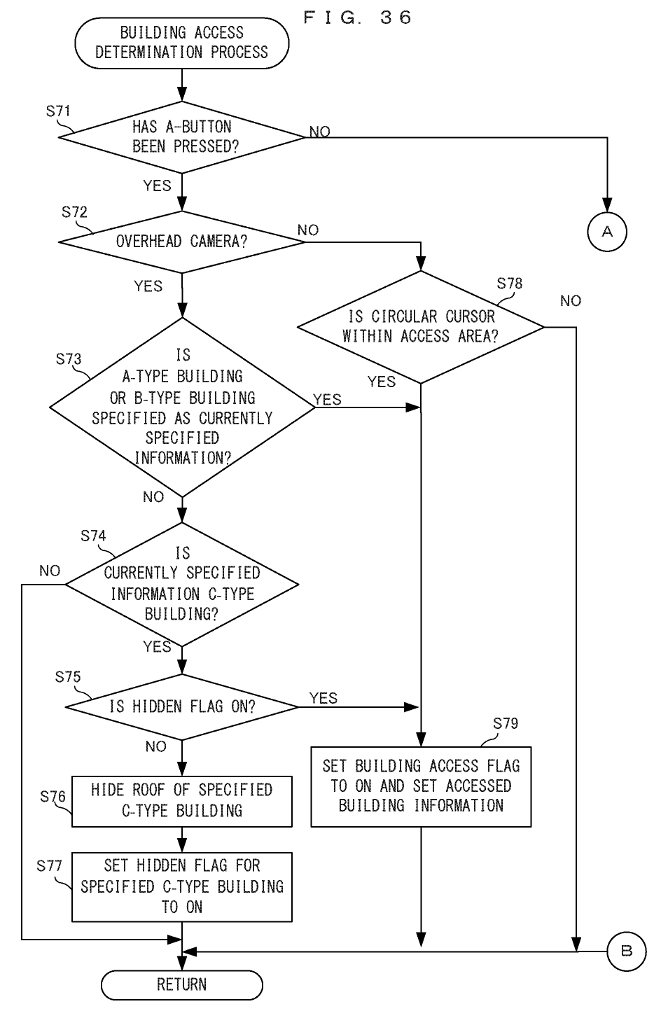

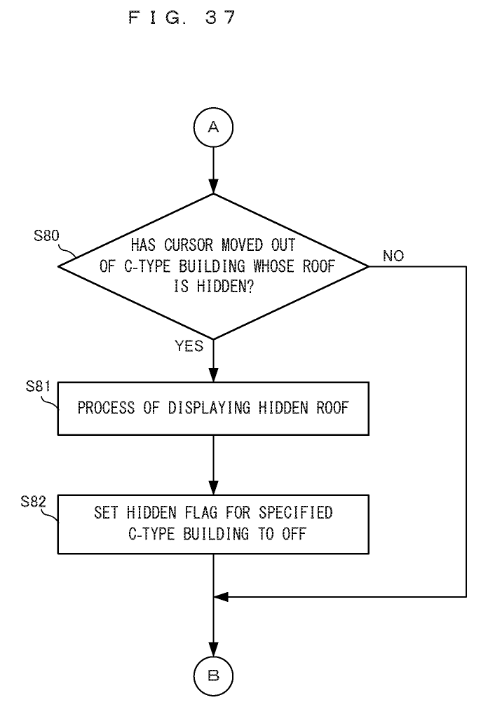

Referring back to FIG. 33, next, the processor 81 executes a building access determination process (S27). FIGS. 36 to 37 are flowcharts showing the details of the building access determination process. First, the processor 81 determines whether or not the A-button 53 has been pressed, based on the button operation data 351 (S71). If the A-button 53 has been pressed (YES in S71), next, the processor 81 determines whether or not the current camera mode is the overhead camera (S72). If the current camera mode is the overhead camera (YES in S72), the processor 81 determines whether or not the building ID 332 of an A‑type building or B‑type building is specified by the currently specified information 313 (S73). If the building ID 332 of an A‑type building or the B‑type building is specified as the currently specified information 313 (YES in S73), the processor 81 sets the building access flag 311 to ON and sets the building ID 332 specified as the currently specified information 313, as the accessed building information 312 (S79). Then, the building access determination process ends.

On the other hand, if, as a result of the determination in S73 above, the building ID 332 of an A‑type building or the B‑type building is not specified as the currently specified information 313 (NO in S73), the processor 81 determines whether or not the building ID 332 of a C‑type building is specified as the currently specified information 313 (S74). If the building ID 332 of a C‑type building is specified as the currently specified information 313 (YES in S74), next, the processor 81 determines whether or not the hidden flag 340 for the C‑type building is ON. If the hidden flag 340 is not ON (NO in S75), the processor 81 performs setting for hiding the roof of the specified C‑type building (S76). Furthermore, the processor 81 sets the hidden flag 340 for the specified C‑type building to ON (S77). Then, the building access determination process ends.

On the other hand, if, as a result of the determination in S75 above, the hidden flag 340 is ON (YES in S75), the processor 81 advances the processing to S79 above.

On the other hand, if, as a result of the determination in S72 above, the current camera mode is the ground camera (NO in S72), the processor 81 determines whether or not the circular cursor is within the access area for any building (S78). It may be determined whether or not, instead of the circular cursor, the reference point is within any access area. If the circular cursor is within the access area for any building (YES in S78), the processor 81 advances the processing to S79 above. If the circular cursor is not within any access area (NO in S78), the process in S79 is skipped, and the building access determination process ends.

On the other hand, if, as a result of the determination in S71 above, the A-button 53 has not been pressed (NO in S71), the processor 81 determines whether or not, while the camera mode is the overhead camera, the state of a C‑type building for which the hidden flag 340 is ON, that is, a C‑type building whose roof is hidden, has been changed from a state where the finger‑shaped cursor overlaps the C‑type building to a state where the finger‑shaped cursor does not overlap the C‑type building (S80). If, as a result of the determination, the state has been changed to a state where the finger‑shaped cursor does not overlap the C‑type building (YES in S80), the processor 81 executes a process of displaying the roof (S81). Furthermore, the processor 81 sets the hidden flag 340 for the C‑type building whose roof had been hidden, to OFF (S82). Then, the building access determination process ends.

On the other hand, if the state of the C‑type building whose roof is hidden has not been changed from a state where the finger‑shaped cursor overlaps the C‑type building to a state where the finger‑shaped cursor does not overlap the C‑type building (NO in S80), the processes in S81 and S82 above are skipped, and the building access determination process ends.

Referring back to FIG. 33, if the building access determination process ends, the user operation process ends.

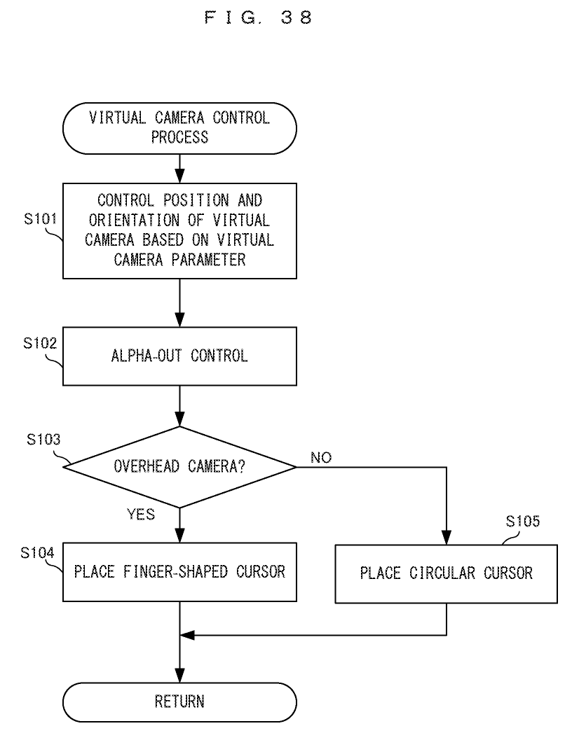

Referring back to FIG. 32, next, the processor 81 executes a virtual camera control process (S13). FIG. 38 is a flowchart showing the details of the virtual camera control process. First, the processor 81 controls the position and the orientation of the virtual camera, based on the camera parameter 308 (S101). At this time, when control in which the virtual camera is moved seamlessly to the C‑type building whose roof is hidden is performed, the seamless movement control is continued until the movement is completed.

Next, the processor 81 performs the above-described alpha-out control (S102). In this example, as described above, when the disk-shaped collision area centered on the virtual camera comes into contact with any of the collision areas of various objects, the alpha‑out is set such that the object is gradually made transparent over time as described above.

Next, the processor 81 determines whether or not the current camera mode is the overhead camera (S103). If the current camera mode is the overhead camera (YES in S103), the processor 81 places the finger‑shaped cursor at the position indicated by the cursor position data 309 (S104). On the other hand, if the current camera mode is the ground camera (NO in S103), the processor 81 places the circular cursor at the position indicated by the cursor position data 309 (S105). Then, the virtual camera control process ends.

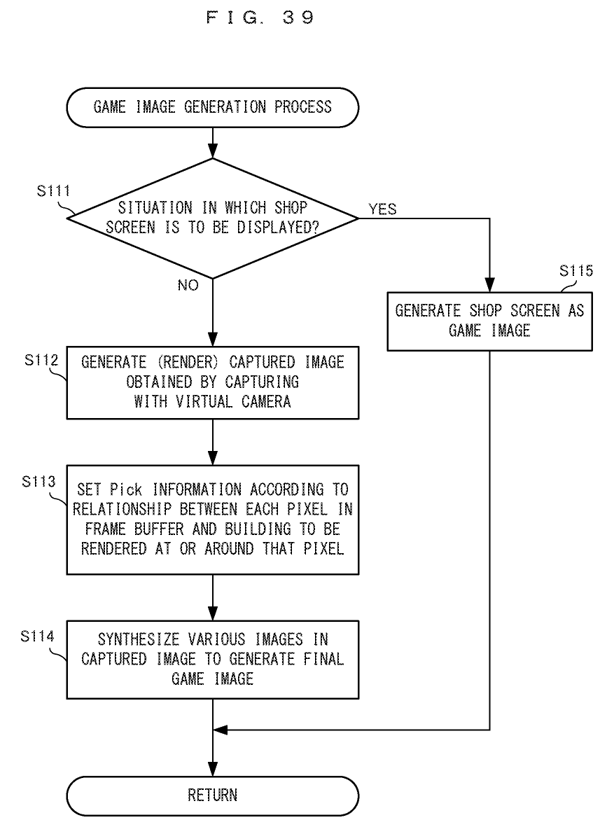

Referring back to FIG. 32, next, the processor 81 executes a game image generation process (S14). FIG. 39 is a flowchart showing the details of the game image generation process. First, the processor 81 determines whether or not the current situation is a situation in which the above shop screen is to be displayed. That is, the processor 81 determines whether or not the building access flag 311 is ON and the building set in the accessed building information 312 is a B‑type building (S111). If, as a result of the determination, the current situation is a situation in which the shop screen is to be displayed (YES in S111), the processor 81 generates the shop screen as a game image (S115).

On the other hand, if the current situation is not a situation in which the shop screen is to be displayed (NO in S111), the processor 81 generates a captured image obtained by capturing the virtual space with the virtual camera (S112). This image is stored in the frame buffer 314.

Next, the processor 81 sets the above-described pick information 316, based on the relationship between each pixel in the frame buffer 314 and the building to be rendered at each pixel (S113). At this time, depending on the building, the building ID 332 is also set for pixels at which the building is not rendered, based on the expansion portion information 339. In addition, for a certain pixel, for example, if the pixel is a pixel at which the building A is rendered and is also included in the expansion portion of the building B, a process is performed such that the building ID 332 of the building A is set for the pixel.

Next, the processor 81 synthesizes various images in the above-described captured image to generate a game image to be finally outputted (S114). Then, the game image generation process ends.

Referring back to FIG. 32, if the game image generation process ends, the normal process ends.

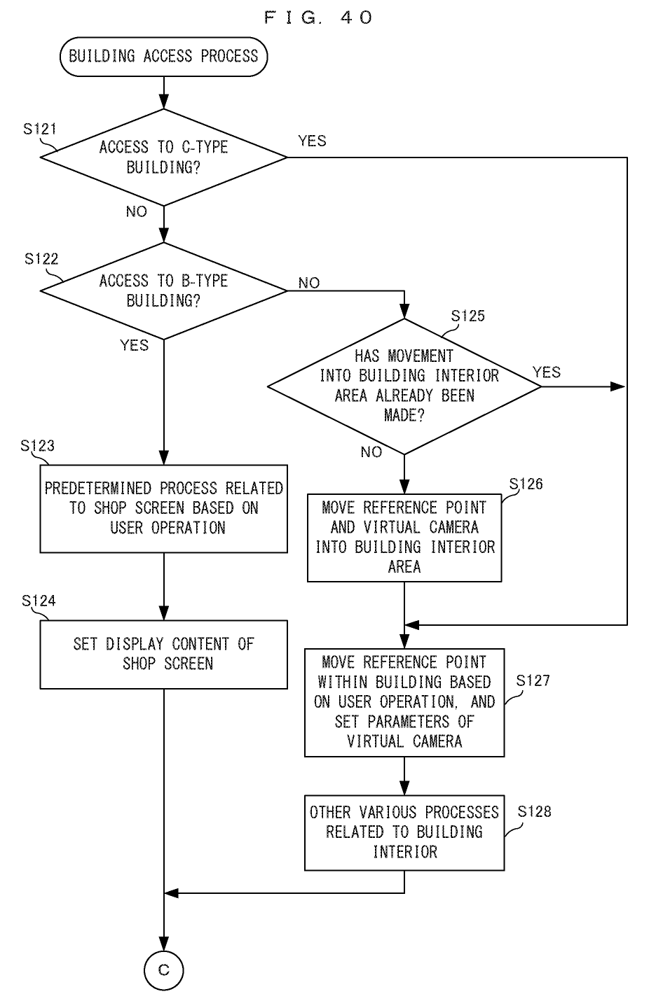

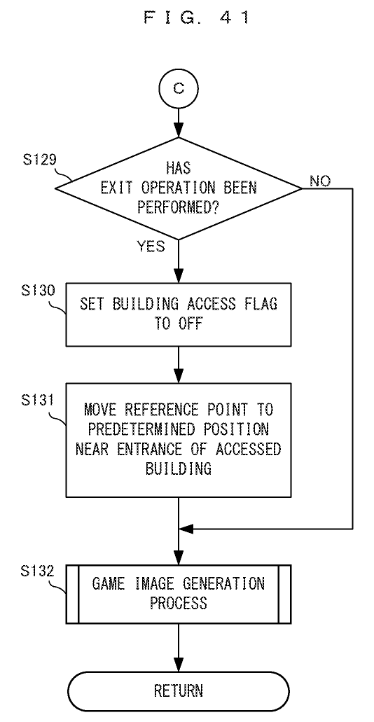

Next, the details of the building access process in S4 in FIG. 31 will be described. FIGS. 40 and 41 are flowcharts showing the details of the building access process. First, the processor 81 determines whether or not the building access is to a C‑type building, based on the accessed building information 312. If, as a result of the determination, the building access is not to a C‑type building (NO in S121), next, the processor 81 determines whether or not the access is to a B‑type building (S122). If, as a result of the determination, the building access is to a B‑type building (YES in S122), the processor 81 executes a predetermined process related to the shop screen, based on an operation performed by the user (S123). Furthermore, the processor 81 sets the display content of the shop screen as appropriate based on the result of the processing (S124). Then, the processor 81 advances the processing to S129 described later.

On the other hand, if, as a result of the determination in S122, the building access is not to a B‑type building (NO in S122), the building access is considered to be to an A‑type building. In this case, first, the processor 81 determines whether or not movement to the building interior area corresponding to the A‑type building to which the building access has been performed has been made (S125). If such movement has not been made (NO in S125), the processor 81 moves the reference point and the virtual camera into the building interior area (S126). At this time, the camera mode is set to the ground camera. If such movement has already been made (YES in S125), the process in S126 is skipped.

Next, the processor 81 moves the reference point within the building interior area, based on an operation performed by the user. Furthermore, the camera parameter 308 such as the gazing point of the virtual camera and the position of the camera is determined based on the reference point. In addition, the position of the cursor is determined based on the reference point (S127).

Next, the processor 81 executes various processes related to the building interior area as appropriate (S128). For example, control of the actions of virtual residents within the building interior area, etc., are performed.

On the other hand, if, as a result of the determination in S121 above, the building access is to a C‑type building (YES in S121: if the virtual camera has moved seamlessly into the interior of the C‑type building), movement to another area has not occurred, and thus the processor 81 advances the processing to S127 above.

Next, the processor 81 determines whether or not an exit operation has been performed (S129). The exit operation, in the case of the A‑type building, is to move the cursor to the exit and perform a predetermined button operation, for example. In the case of the B‑type building, the exit operation is, for example, to operate an “Exit Button” displayed on the shop screen. In the case of the C‑type building, the exit operation is, for example, to perform an operation for moving from the exit toward the outside of the building. If, as a result of the determination, the exit operation has been performed (YES in S129), the processor 81 sets the building access flag 311 to OFF (S130). Next, the processor 81 moves the reference point to a predetermined position near the entrance of the building that has been accessed, in the virtual town, and also moves the virtual camera accordingly (S131). In addition, the camera mode when exiting the building may be set to the camera mode that had been set before the building access. For example, if the building access is performed to the A‑type building in the state of the overhead camera, control may be performed with the ground camera inside the building, and control of returning to the overhead camera may be performed upon exiting.

For the C‑type building, the timing at which the once‑hidden roof is displayed again may be set to the timing at which the exit operation is performed.

On the other hand, if the exit operation has not been performed (NO in S129), the processes in S130 and S131 above are skipped.

Next, the processor 81 executes the above-described game image generation process (S132). This process is the same as the process in S14 described with reference to FIG. 39 above, and thus the description thereof is omitted. Then, the building access process ends.

Referring back to FIG. 31, after the normal process or the building access process, the processor 81 outputs the game image generated by the above process (S5).

Next, the processor 81 determines whether or not a condition for ending the game is satisfied (S6). If the condition is not satisfied (NO in S6), the processor 81 returns to the process in S2 above and repeats the processing. If the condition is satisfied (YES in S6), the processor 81 ends the game processing.

This is the end of the detailed description of the game processing according to the exemplary embodiment.

Through the processing described above, in the case of the overhead camera and in the case of the ground camera, building access operation methods corresponding to the respective cases are provided. Accordingly, an appropriate operation method corresponding to the position of the virtual camera can be provided.

### Modifications

In the above embodiment, regarding the building access, when the finger‑shaped cursor overlaps a building in the case of the overhead camera, switching to the ground camera may be restricted. Alternatively, when switching to the ground camera is made in a state where the finger‑shaped cursor overlaps a building in the case of the overhead camera, the reference point may be moved such that the ground cursor is not included outside the cursor collision area.

In the above embodiment, the reference point is moved in the world coordinate system, but in another exemplary embodiment, the reference point may be moved in a screen coordinate system.

In the above example, the cursor position and the gazing point are determined based on the reference point, but in another exemplary embodiment, the reference point does not have to be used. For example, one or both of the cursor and the gazing point may be directly controlled based on a directional input of the left stick 32. Alternatively, for example, when the cursor is operated with the left stick 32, the gazing point may be determined based on the position of the cursor, or vice versa.

Regarding the building access to the C‑type building, in addition to the examples described above, when the user presses the A-button 53 in a state where the roof is hidden, the building access may be enabled. In addition, after the finger‑shaped cursor is aligned with the C‑type building, even without hiding the roof as described above, if the user performs an operation for switching from the overhead camera to the ground camera, the building access to the C‑type building may be enabled.

For example, the above processor may mean one or more processors in one apparatus such as a main body apparatus or may mean some or all of one or more processors included in each of multiple apparatuses such as a main body apparatus and a controller or a main body apparatus, a controller, and a server. The same applies to the memory of the information processing system and other components.

The program that causes a computer to execute each process may be a single program or may be a program group including a plurality of programs. The “certain program” does not necessarily mean a single program and may include a program group. In addition, the entirety of the program does not need to be stored in one apparatus. The “certain program” may mean, for example, the totality of programs that are stored in a plurality of apparatuses included in the information processing system, respectively.

In an information processing system including a terminal-side apparatus and a server-side apparatus capable of communicating via a network, at least part of the series of processes described above may be executed by the server-side apparatus. The server may be composed of a plurality of information processing apparatuses, and the processes may be executed by the plurality of information processing apparatuses in a shared manner.

While the exemplary embodiment and the modifications have been described, the description thereof is in all aspects illustrative and not restrictive. It is to be understood that various other modifications and variations may be made to the exemplary embodiment and the modifications.

While the present disclosure has been described in detail, the foregoing description is in all aspects illustrative and not restrictive. It is to be understood that numerous other modifications and variations can be devised without departing from the scope of the present disclosure.

What is claimed is:

1. One or more non-transitory computer-readable storage media having stored therein instructions that, when executed, cause one or more processors to perform operations comprising:
switching between a first mode and a second mode based on an operation input;
in the first mode,
moving a reference point based on an operation input,
setting a gazing point of a virtual camera within a virtual space including a virtual plane on which a first‑type object is placed, based on the reference point,
generating, based on the virtual camera, a first game image in which a first cursor is displayed at a predetermined position, and
executing a first process related to the first‑type object when the first cursor overlaps the first‑type object and a determination instruction is made based on an operation input; and
in the second mode,
placing the virtual camera at a position closer to the virtual plane than a position of the virtual camera in the first mode,
moving the reference point based on an operation input,
generating, based on the virtual camera, a second game image in which a second cursor is displayed at a position, on the virtual plane, determined based on the reference point,
hiding at least a part of the first‑type object when the first‑type object is positioned within a predetermined range from the virtual camera,
setting the gazing point such that a first area where the first‑type object is placed does not overlap the second cursor, in setting of the gazing point based on the reference point, and
executing the first process related to the first‑type object when the determination instruction is made based on an operation input when a second area that includes at least an area not overlapping the first area and corresponds to a position at which the first‑type object is placed overlaps the second cursor.

2. The one or more non-transitory computer-readable storage media according to claim 1, wherein the operations further comprise, based on an operation input, placing the first‑type object at a position, in the virtual space, based on the operation input.

3. The one or more non-transitory computer-readable storage media according to claim 1, wherein the operations further comprise setting the gazing point based on the reference point such that the second cursor is displayed at a position overlapping the first area, when the first cursor overlaps the first‑type object and switching is made from the first mode to the second mode based on the operation input.

4. The one or more non-transitory computer-readable storage media according to claim 1, wherein the operations further comprise restricting switching from the first mode to the second mode based on the operation input when the first cursor overlaps the first‑type object.

5. The one or more non-transitory computer-readable storage media according to claim 1, wherein the operations further comprise setting the gazing point such that the second cursor is displayed at a position not overlapping the first area, when the first cursor overlaps the first‑type object and switching is made from the first mode to the second mode based on the operation input.

6. The one or more non-transitory computer-readable storage media according to claim 1, wherein a depression angle of the virtual camera in the first mode is smaller than a depression angle of the virtual camera in the second mode.

7. The one or more non-transitory computer-readable storage media according to claim 1, wherein the operations further comprise controlling a height of the virtual camera in the virtual space, based on a height of the reference point in the virtual space, in the second mode.

8. The one or more non-transitory computer-readable storage media according to claim 7, wherein the operations further comprise:
when the height of the reference point has changed from a first height to a second height, setting the height of the virtual camera from a height based on the first height to a height based on the second height; and
when the height of the reference point has changed from the second height to the first height, setting the height of the virtual camera to the height based on the second height.

9. The one or more non-transitory computer-readable storage media according to claim 1, wherein the operations further comprise:
in the first mode,
executing a second process related to a second-type object when the first cursor overlaps the second-type object and the determination instruction is made, and
executing the first process related to the second-type object when the first cursor overlaps the second-type object and switching is made from the first mode to the second mode based on the operation input; and
in the second mode,
executing the first process related to the second-type object when the determination instruction is made when a third area corresponding to a position at which the second-type object is placed overlaps the second cursor.

10. The one or more non-transitory computer-readable storage media according to claim 1, wherein
data regarding the first‑type object is embedded in a pixel in a first range in the first game image, the first range including pixels at which the first‑type object is displayed, and
the operations further comprise executing the first process related to the first‑type object when the determination instruction is made when the first cursor overlaps the pixel in which the data regarding the first‑type object is embedded.

11. The one or more non-transitory computer-readable storage media according to claim 10, wherein the first range is wider than a range where the first‑type object is displayed.

12. The one or more non-transitory computer-readable storage media according to claim 11, wherein the operations further comprise displaying a first label indicating the first‑type object, at a pixel in a second range which is at least a part of the first range in the first game image.

13. The one or more non-transitory computer-readable storage media according to claim 12, wherein the operations further comprise executing the first process related to another first‑type object when the determination instruction is made when a pixel which is included in the first area and at which the first‑type object is not displayed but the other first‑type object is displayed overlaps the first cursor.

14. The one or more non-transitory computer-readable storage media according to claim 13, wherein the operations further comprise:
when a pixel which is a pixel in the second range and at which the other first‑type object is displayed does not overlap the first cursor, displaying the first label and the other first‑type object at said pixel in an overlapping manner; and
when a pixel which is a pixel in the second range and at which the other first‑type object is displayed overlaps the first cursor, hiding the first label and displaying the other first‑type object at said pixel.

15. The one or more non-transitory computer-readable storage media according to claim 1, wherein the operations further comprise increasing a transparency of the first‑type object over time when the first‑type object is positioned within a first distance in a direction based on a direction of a line of sight of the virtual camera.

16. A game apparatus comprising
one or more processors, and
one or more non-transitory computer-readable storage media having stored therein instructions that, when executed, cause the one or more processors to perform operations comprising:
switching between a first mode and a second mode based on an operation input;
in the first mode,
moving a reference point based on an operation input,
setting a gazing point of a virtual camera within a virtual space including a virtual plane on which a first‑type object is placed, based on the reference point,
generating, based on the virtual camera, a first game image in which a first cursor is displayed at a predetermined position, and
executing a first process related to the first‑type object when the first cursor overlaps the first‑type object and a determination instruction is made based on an operation input; and
in the second mode,
placing the virtual camera at a position closer to the virtual plane than a position of the virtual camera in the first mode,
moving the reference point based on an operation input,
generating, based on the virtual camera, a second game image in which a second cursor is displayed at a position, on the virtual plane, determined based on the reference point,
hiding at least a part of the first‑type object when the first‑type object is positioned within a predetermined range from the virtual camera,
setting the gazing point such that a first area where the first‑type object is placed does not overlap the second cursor, in setting of the gazing point based on the reference point, and
executing the first process related to the first‑type object when the determination instruction is made based on an operation input when a second area that includes at least an area not overlapping the first area and corresponds to a position at which the first‑type object is placed overlaps the second cursor.

17. A game system comprising
one or more processors, and
one or more non-transitory computer-readable storage media having stored therein instructions that, when executed, cause the one or more processors to perform operations comprising:
switching between a first mode and a second mode based on an operation input;
in the first mode,
moving a reference point based on an operation input,
setting a gazing point of a virtual camera within a virtual space including a virtual plane on which a first‑type object is placed, based on the reference point,
generating, based on the virtual camera, a first game image in which a first cursor is displayed at a predetermined position, and
executing a first process related to the first‑type object when the first cursor overlaps the first‑type object and a determination instruction is made based on an operation input; and
in the second mode,
placing the virtual camera at a position closer to the virtual plane than a position of the virtual camera in the first mode,
moving the reference point based on an operation input,
generating, based on the virtual camera, a second game image in which a second cursor is displayed at a position, on the virtual plane, determined based on the reference point,
hiding at least a part of the first‑type object when the first‑type object is positioned within a predetermined range from the virtual camera,
setting the gazing point such that a first area where the first‑type object is placed does not overlap the second cursor, in setting of the gazing point based on the reference point, and
executing the first process related to the first‑type object when the determination instruction is made based on an operation input when a second area that includes at least an area not overlapping the first area and corresponds to a position at which the first‑type object is placed overlaps the second cursor.

18. A computer-implemented method comprising:
switching between a first mode and a second mode based on an operation input;
in the first mode,
moving a reference point based on an operation input,
setting a gazing point of a virtual camera within a virtual space including a virtual plane on which a first‑type object is placed, based on the reference point,
generating, based on the virtual camera, a first game image in which a first cursor is displayed at a predetermined position, and
executing a first process related to the first‑type object when the first cursor overlaps the first‑type object and a determination instruction is made based on an operation input; and
in the second mode,
placing the virtual camera at a position closer to the virtual plane than a position of the virtual camera in the first mode,
moving the reference point based on an operation input,
generating, based on the virtual camera, a second game image in which a second cursor is displayed at a position, on the virtual plane, determined based on the reference point,
hiding at least a part of the first‑type object when the first‑type object is positioned within a predetermined range from the virtual camera,
setting the gazing point such that a first area where the first‑type object is placed does not overlap the second cursor, in setting of the gazing point based on the reference point, and
executing the first process related to the first‑type object when the determination instruction is made based on an operation input when a second area that includes at least an area not overlapping the first area and corresponds to a position at which the first‑type object is placed overlaps the second cursor.
